(19) United States
(12) Patent Application Publication
(10) Pub. No.: US 2025/0279577 A1
(43) Pub. Date: Sep. 4, 2025

(54) ANTENNA ARRAY AND GROUND STATION

(71) Applicant: Chiun Mai Communication Systems, Inc., New Taipei (TW)

(72) Inventors: PO-CHIH LIN, New Taipei (TW); Chia-Hung Su, New Taipei (TW); Chang-Ching Huang, New Taipei (TW); Chia-Ming Liang, New Taipei (TW); Shu-Wei Jhang, New Taipei (TW)

(21) Appl. No.: 19/066,490

(22) Filed: Feb. 28, 2025

(30) Foreign Application Priority Data
Feb. 29, 2024 (CN) 202410229383.3

(51) Int. Cl. H01Q 1/28; H01Q 9/04; H01Q 21/24

(52) U.S. Cl. CPC H01Q 1/288; H01Q 9/0414; H01Q 21/24

(57) ABSTRACT

An antenna array and a ground station, including at least one radiation module and a feeding module, the radiation module includes a radiation layer and a dielectric layer arranged in stack, the radiation layer includes a plurality of radiators, each radiator radiates signals; the feeding module includes a coupling layer arranged in stack, the feeding layer includes a plurality of first feed lines and second feed lines being one-to-one correspondingly arranged to form a plurality of feeding units being one-to-one corresponding to the radiators and feed current to the radiators; the coupling layer couples the current flowing through the feeding units to the radiation module; the coupling layer is provided with a plurality of first coupling slots and second coupling slots arranged in one-to-one correspondence, to form a plurality of coupling units.

### CROSS-REFERENCE TO RELATED APPLICATIONS

This application claims priority to Chinese Patent Application No. 202410229383.3 filed on Feb. 29, 2024, in China National Intellectual Property Administration, the contents of which are incorporated by reference herein.

### FIELD

The subject matter herein generally relates to antenna technology field, and more particularly to an antenna array and a ground station.

### BACKGROUND

Low-orbit satellite system (LEO) is a large satellite system composed of multiple satellites that can process real-time information. In the related technologies of low-orbit satellite systems, the antenna used to achieve communication between the ground station and the low-orbit satellite uses a circularly polarized antenna, which can avoid polarization loss of the signal on the transmission path and improve the reliability of the signal. The antenna can achieve circular polarization by setting two feed sources with a phase difference of 90 degrees between the two feed sources. Low-orbit satellite systems use antenna arrays to transmit and receive signals, and the performance of antenna arrays is easily affected by space, such as mutual influence between multiple antenna units, or mutual influence between two feed sources of the same antenna unit. Due to the limitation of antenna array area, antenna units or feed sources may be coupled and interfered with each other, which reduces the radiation efficiency of the antenna array and greatly limits the communication capability between satellites and ground stations or other satellites.

### BRIEF DESCRIPTION OF THE DRAWINGS

Implementations of the present disclosure will now be described, by way of embodiments, with reference to the attached figures.

FIG. 1 is a top view diagram of an antenna array according to an embodiment of the present application.

FIG. 2 is a cross-sectional view diagram of a radiation unit of the antenna array obtained along a section line II-II of FIG. 1.

FIG. 3 is an exploded diagram of the radiation unit of FIG. 2.

FIG. 4 is a structural diagram of a feeding module of the radiation unit of FIG. 1.

FIG. 5 is a structural diagram of a coupling layer of a first specific embodiment of the present application.

FIG. 6 is a schematic diagram of a current path of the coupling layer shown in FIG. 5.

FIG. 7 is a scattering parameter (S-parameter) diagram of the radiation unit using the coupling layer of FIG. 5.

FIG. 8 is an antenna gain diagram of the radiation unit using the coupling layer of FIG. 5.

FIG. 9 is a structural diagram of a coupling layer of a second specific embodiment of the present application.

FIG. 10 is a schematic diagram of a current path of the coupling layer shown in FIG. 9.

FIG. 11 is a scattering parameter (S-parameter) diagram of the radiation unit using the coupling layer of FIG. 9.

FIG. 12 is an antenna gain diagram of the radiation unit using the coupling layer of FIG. 9.

FIG. 13 is a structural diagram of a coupling layer of a third specific embodiment of the present application.

FIG. 14 is a scattering parameter (S-parameter) diagram of the radiation unit using the coupling layer of FIG. 13.

FIG. 15 is an antenna gain diagram of the radiation unit using the coupling layer of FIG. 13.

FIG. 16 is a structural diagram of a coupling layer of a fourth specific embodiment of the present application.

FIG. 17 is a scattering parameter (S-parameter) diagram of the radiation unit using the coupling layer of FIG. 16.

FIG. 18 is an antenna gain diagram of the radiation unit using the coupling layer of FIG. 16.

FIG. 19 is a structural diagram of a coupling layer of a fifth specific embodiment of the present application.

FIG. 20 is a scattering parameter (S-parameter) diagram of the radiation unit using the coupling layer of FIG. 19.

FIG. 21 is an antenna gain diagram of the radiation unit using the coupling layer of FIG. 19.

FIG. 22 is a structural diagram of a coupling layer of a sixth specific embodiment of the present application.

FIG. 23 is a scattering parameter (S-parameter) diagram of the radiation unit using the coupling layer of FIG. 22.

FIG. 24 is an antenna gain diagram of the radiation unit using the coupling layer of FIG. 22.

FIG. 25 is a structural diagram of a coupling layer of a seventh specific embodiment of the present application.

FIG. 26 is a scattering parameter (S-parameter) diagram of the radiation unit using the coupling layer of FIG. 25.

FIG. 27 is an antenna gain diagram of the radiation unit using the coupling layer of FIG. 25.

FIG. 28 is a structural diagram of a coupling layer of a eighth specific embodiment of the present application.

FIG. 29 is a scattering parameter (S-parameter) diagram of the radiation unit using the coupling layer of FIG. 28.

FIG. 30 is an antenna gain diagram of the radiation unit using the coupling layer of FIG. 28.

FIG. 31 is a structural diagram of a coupling layer of a ninth specific embodiment of the present application.

FIG. 32 is a schematic diagram of a current path of the coupling layer shown in FIG. 31.

FIG. 33 is a scattering parameter (S-parameter) diagram of the radiation unit using the coupling layer of FIG. 31.

FIG. 34 is a cross-sectional view diagram of the radiation unit according to another embodiment of the present application.

FIG. 35 is an exploded diagram of the radiation unit of FIG. 34.

FIG. 36 is a block diagram of a radio frequency (RF) module according to an embodiment of the present application.

FIG. 37 is a block diagram of an electronic device according to an embodiment of the present application.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or another word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series, and the like.

Low-orbit satellite system (LEO) is a large satellite system composed of multiple satellites that can process real-time information. In the related technologies of low-orbit satellite systems, the antenna gain used to realize communication between ground stations and low-orbit satellites is low and cannot well meet user needs, which greatly limits the communication ability of satellites to communicate with ground stations or other satellites.

Based on this, this application provides an antenna array that can be applied to ground stations to achieve communication among low-orbit satellites, and the antenna array has high antenna gain.

### Embodiment I

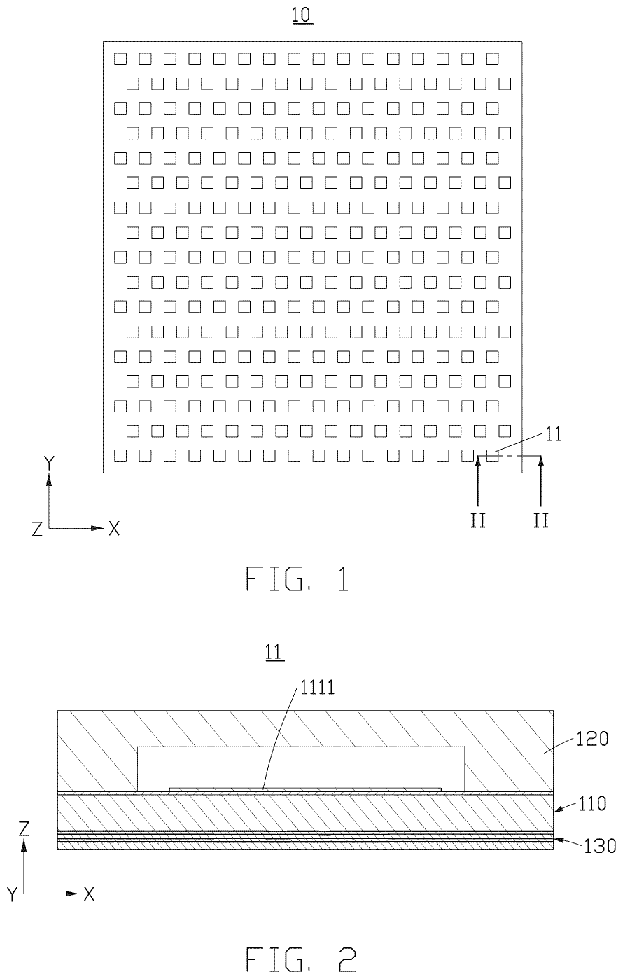

Referring to FIG. 1, FIG. 1 illustrates an overall schematic diagram of an antenna array 10 provided by the present application. The antenna array 10 includes at least one radiation module and a feeding module arranged in a stack. The radiation module is used to transmit or receive signals, the feeding module is used to provide feed power to the radiation module. It can be understood that the at least one radiation module and the feeding module form the antenna array 10 including a plurality of radiation units 11. In the following embodiments, a structural schematic diagram of a radiation unit 11 in the antenna array 10 is used as an example to illustrate the specific structure of the antenna array 10.

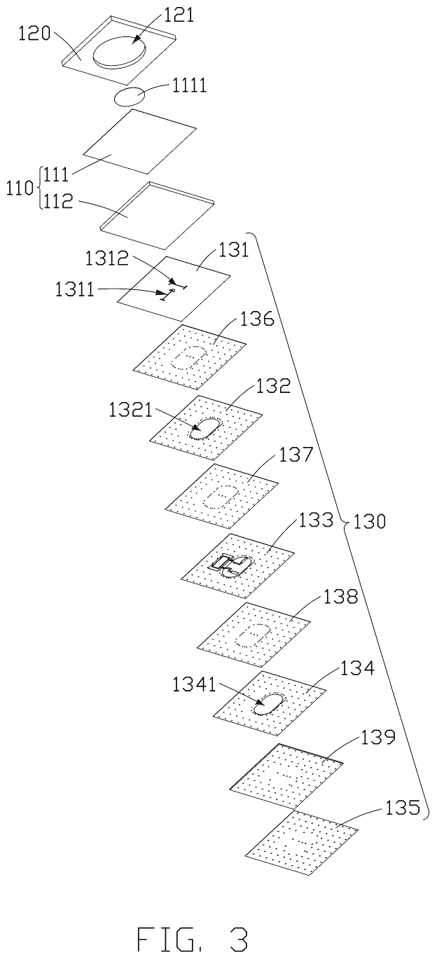

Referring to FIG. 2, FIG. 2 illustrates a cross-sectional view diagram of one of the plurality of radiation units 11 of the antenna array 10. In the antenna array 10 of the present embodiment, the at least one radiation module includes a first radiation module 110. Referring to FIG. 3, the first radiation module 110 includes a first radiation layer 111 and a first dielectric layer 112 arranged in stack. The first radiation layer 111 includes a plurality of first radiators 1111, each of the plurality of first radiators 1111 is configured to radiate signals. In some embodiment, the first radiation layer 111 may be a printed circuit board, or a board made of ceramic material or plastic material board, or the like. The first radiator 1111 may be a metal coating formed on the first radiation layer 111 or other sheets made of conductive materials. The first radiator 1111 is formed on a surface of the first radiation layer 111 away from the first dielectric layer 112. The first dielectric layer 112 is made of non-conductive material. For instance, in some embodiments, the first dielectric layer 112 may be made of a material with a dielectric material coefficient of about 2.4. Specifically, the first dielectric layer 112 may be made of a ceramic material or a plastic material. Specifically, in some embodiments, the first radiator 1111 is a substantially circular copper sheet. The first radiation layer 111 and the first dielectric layer 112 are both substantially square. An area of each of the first radiating layer 111 and the first dielectric layer 112 is greater than an area of the first radiator 1111. It is understandable that the first radiator 111 may be made of conductive metal materials such as copper, aluminum, and silver.

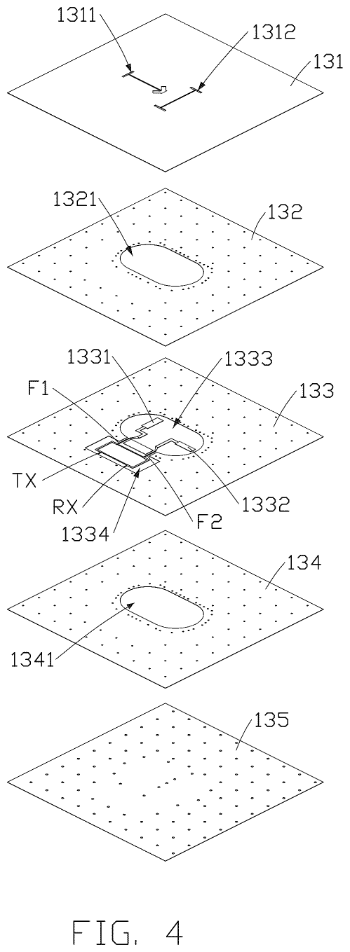

Referring to FIGS. 3 and 4, the antenna array 10 further includes a feeding module 130. The feeding module 130 is arranged on a side of the first radiation module 110 closes to the first dielectric layer 112. The feeding module 130 includes a feeding layer 133 and a coupling layer 131 arranged in a stack. The feeding layer 133 is provided with a plurality of first feed lines 1331 and a plurality of second feed lines 1332. The first feed lines 1331 and the second feed lines 1332 are arranged in one-to-one correspondence, forming a plurality of feeding units. The feeding units correspond to the first radiators 1111 on the first radiation layers 111 one-to-one, the feeding units are used to feed currents for the corresponding first radiators 1111. In an embodiment of the present application, the one-to-one correspondence arrangement means that in a projection along the Z-axis direction of the antenna array, the projected areas of the two structures arranged in one-to-one correspondence at least partially overlap. Thus, the feeding units and the first radiators 1111 on the first radiation layers 111 are arranged in one-to-one correspondence. That is to say, in the projection along the Z-axis direction of the antenna array 10, a projected area of the feeding units and a projected area of the first radiators 1111 at least partially overlap each other. For instance, in the projection along the Z-axis direction of the antenna array 10, the projected area of the feeding units completely overlaps the projected area of the first radiators 1111, or the projected area of the feeding units and the projected area of the first radiators 1111 partially overlap each other. Based on this, the plurality of first feed lines 1331 and the plurality of second feed lines 1332 are in one-to-one correspondence arrangement means that in the feeding layer 133, the first feed lines 1331 and the second feed lines 1332 corresponding to a same first radiator 1111, that is, in the projection along the Z-axis direction of the antenna array 10, a projected area of the first radiator 1111 and a projected area of the first feed line 1331 and the second feed line 1332 overlap or at least partially overlap each other. In an embodiment of the present application, there is an included angle between the first feed line 1331 and the second feed line 1332, so as to generate polarized waves in two different directions, especially horizontally polarized waves and vertically polarized waves.

The coupling layer 131 is arranged on a side of the feeding layer 133 closes to the first radiation module 110, that is, the coupling layer 131 is arranged close to the first dielectric layer 112 of the first radiation module 110, specifically arranged on a side of the first dielectric layer 112 away from the first radiation layer 111. The coupling layer 131 is used to couple a current signal flowing through the feed line unit to the first radiation module 110.

The coupling layer 131 is provided with a plurality of first coupling slots 1311 and a plurality of second coupling slots 1312 (see FIG. 4). The plurality of first coupling slots 1311 and the plurality of second coupling slots 1312 are arranged in one-to-one correspondence to form a plurality of coupling units. The first coupling slot 1311 and the second coupling slot 1312 of the coupling unit are spaced apart from each other. Thus, when the coupling layer 131 couples the current signal flowing through the feeding units to the first radiation module 110, the coupling layer 131 changes the path and direction of the current of the coupling layer 131 through the first coupling slots 1311 and the second coupling slots 1312, which can reduce a coupling interference between the first feeding line 1331 and the second feeding line 1332, improve an isolation between the first feeding line 1331 and the second feeding line 1332, and reduce an interference influence of the antenna array 10.

In some embodiments, the plurality of first coupling slots 1311 and the plurality of second coupling slots 1312 have different directions, so that an extension line of the first coupling slots 1311 and an extension line of the second coupling slots 1312 of the coupling unit intersect.

In some embodiments, the first coupling slot 1311 and the second coupling slot 1312 of the coupling unit are perpendicular to each other and spaced apart (as shown in FIGS. 3 and 4). It can be understood that when the first coupling slot 1311 and the second coupling slot 1312 are perpendicular to each other, an angle between the extension line of the first coupling slot 1311 and the extension line of the second coupling slot 1312 is 90°. In some other embodiments, the angle between the extension line of the first coupling slot 1311 and the extension line of the second coupling slot 1312 can be 30°, 45°, 55°, etc., a specific value of the angle between the extension line of the first coupling slot 1311 and the extension line of the second coupling slot 1312 is not limited by the embodiments of the present application.

Further, at least one end of the first coupling slot 1311 and the second coupling slot 1312 of the coupling unit is formed with a port shape. It can be understood that at least one end may be one end, two ends, three ends, or four ends of the first coupling slot 1311 and the second coupling slot 1312 of the coupling unit. The port shape may be formed with an angle. When the end of the first coupling slot 1311 is formed with a port shape, the angle formed by the port shape of the first coupling slot 1311 may be toward or away from the first coupling slot 1311. When the end of the second coupling slot 1312 is formed with a port shape, the angle formed by the port shape of the second coupling slot 1312 may be toward or away from the second coupling slot 1312.

In some embodiments, the plurality of first coupling slots 1311 and the plurality of second coupling slots 1312 have different shapes. For example, the first coupling slot 1311 is in the shape of a unidirectional arrow as a whole, and the second coupling slot 1312 is in the shape of a bidirectional arrow as a whole. Or, the first coupling slot 1311 is in the shape of a bidirectional arrow as a whole, and the second coupling slot 1312 is in the shape of a unidirectional arrow as a whole. Or, the first coupling slot 1311 is in the shape of an H-shaped as a whole, and the second coupling slot 1312 is in the shape of a unidirectional arrow or a bidirectional arrow as a whole, and vice versa. Another example, the first coupling slot 1311 is in the shape of a unidirectional arrow as a whole, and the second coupling slot 1312 is in the shape of a long strip shaped as a whole. The embodiments of the present application do not limit these.

Of course, in other embodiments, the plurality of first coupling slots 1311 and the plurality of second coupling slots 1312 have a same shape. For example, the first coupling slot 1311 and the second coupling slot 1312 are both unidirectional arrows or bidirectional arrows.

Furthermore, each coupling unit is disposed in one-to-one correspondence with the feeding unit, the first coupling slot 1311 is disposed in correspondence with the corresponding first feeding line 1331, and the second coupling slot 1312 is disposed in correspondence with the corresponding second feeding line 1332. In the embodiment, the shape of the first coupling slot 1311 and the projection shape of the first feeding line 1331 in the Z-axis direction of the antenna array 10 may be the same or different, and the shape of the second coupling slot 1312 and the projection shape of the second feeding line 1332 in the Z-axis direction of the antenna array 10 may be the same or different, but the first coupling slot 1311 and the second coupling slot 1312 need to be narrow and long as a whole to achieve the coupling effect, such as an ellipse. Thus, the coupling layer 131 couples the current signal flowing through the feeding unit to the first radiation module 110 through the first coupling slot 1311 and the second coupling slot 1312. In other embodiments, the coupling layer 131 may be replaced by a first coupling layer and a second coupling layer (not shown), and the first coupling layer is provided with a first coupling slot corresponding to the first feeding line 1331, and the second coupling layer is provided with a second coupling slot corresponding to the second feeding line 1332. Thus, the current signal flowing through the feeding unit can also be coupled to the first radiation module 110 through the design of the first coupling layer and the second coupling layer.

In some embodiments, along the projection direction of the Z axis of the antenna array 10, the projection of the first coupling slot 1311 and the projection of the corresponding first feeding line 1331 are perpendicular to each other, and the projection of the second coupling slot 1312 and the projection of the corresponding second feeding line 1332 are perpendicular to each other, so the current signals of the first feeding line 1331 and the second feeding line 1332 can be better coupled to the first radiation module 110 through the first coupling slot 1311 and the second coupling slot 1312.

It can be understood that if a distance between a midpoint of the first coupling slot 1311 and the second coupling slot 1312 is too close, the first coupling slot 1311 and the second coupling slot 1312 will interfere with each other, while if the distance is too far, the size of the antenna array 10 will be too large. Based on this, in the embodiment of the present application, the distance is set to one-sixth of a wavelength, and the distance between an end of the first coupling slot 1311 close to the corresponding second coupling slot 1312 and the second coupling slot 1312 is set to one-twelfth of the wavelength. In some specific examples, one-sixth of the wavelength is about 4.6 millimeters (mm), and one-twelfth of the wavelength is about 1.65 mm. In some other specific examples, one-sixth of the wavelength is 4 mm, and one-twelfth of the wavelength is 2 mm.

Furthermore, in some embodiments, the feeding module 130 further includes a first cavity layer 132, a second cavity layer 134, and a ground layer 135. The first cavity layer 132 is disposed between the feeding layer 133 and the coupling layer 131, and the second cavity layer 134 is disposed between the feeding layer 133 and the ground layer 135. The first cavity layer 132 is provided with a plurality of first through cavities 1321, and the second cavity layer 134 is provided with a plurality of second through cavities 1341. The first through cavities 1321 and the second through cavities 1341 are both provided in one-to-one correspondence with the first radiators 1111. A projection area of each of the first through cavities 1321 and each of the second through cavities 1341 in the projection direction along the Z axis of the antenna array 10 at least partially overlap with the projection area of the corresponding first radiator 1111 in the projection direction along the Z axis.

In the embodiment of the present application, the first cavity layer 132 is disposed between the feeding layer 133 and the coupling layer 131, and the second cavity layer 134 is disposed between the feeding layer 133 and the ground layer 135, so as to isolate the coupling layer 131, the feeding layer 133, and the ground layer 135, and also to increase the antenna height of the antenna array 10, thereby increasing the antenna gain of the antenna array 10.

The feeding layer 133 is provided with a plurality of first receiving grooves 1333 (see FIG. 4), and the first receiving grooves 1333 penetrate the feeding layer 133. Each first feed line 1331 and each second feed line 1332 are respectively disposed in the corresponding first receiving groove 1333.

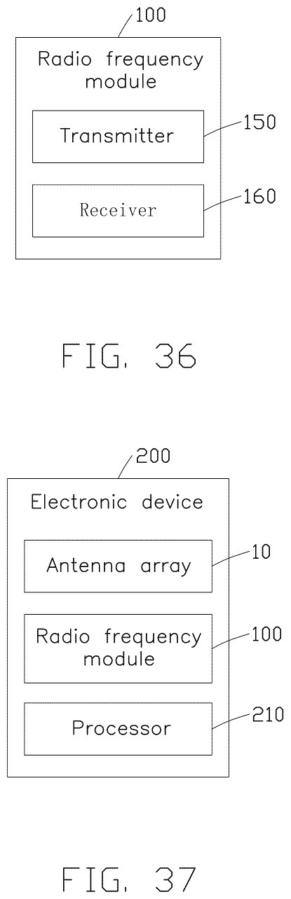

Further, in some embodiments, the feeding module 130 further includes a plurality of phase couplers 1334. The phase couplers 1334 are used to realize signal transmission between the antenna array 10 and signal transceivers (see FIG. 36, including a transmitter 150 and a receiver 160). The phase couplers 1334 may be arranged on the feeding layer 133. In this embodiment, the phase couplers 1334 are arranged in the first receiving groove 1333 of the feeding layer 133. Specifically, the first feed line 1331 and the second feed line 1332 are both generally elongated microstrip lines. The phase coupler 1333 is substantial a square ring-shaped metal ring. The first receiving groove 1333 includes a first groove 13331 and a second groove 13332 that communicate with each other. The phase coupler 1334 is arranged in the first groove 13331, the first feed line 1331 and the second feed line 1332 are arranged in the second groove 13332. The shapes of the first groove 13331 and the second groove 13332 can be set according to the relationship between the first feed line 1331 and the second feed line 1332. Specifically, when the first feed line 1331 and the second feed line 1332 need to be set to be equal in length and extend in different directions, the shape of the first groove 13331 can be set to be square, and the shape of the second groove 13332 can be set to be circular or elliptical. Of course, it is understood that the specific shape of the first receiving groove 1333 in the embodiment of the present application is not limited thereto and can be set according to actual needs.

The phase coupler 1334 includes a signal receiving end RX, a signal transmitting end TX, a first signal feeding end F1, and a second signal feeding end F2. The signal receiving end RX and the signal transmitting end TX are arranged on one side of the phase coupler 1333, the first signal feeding end F1 and the second signal feeding end F2 are arranged on the other side of the phase coupler 1333 away from the signal receiving end RX and the signal transmitting end TX. Each phase coupler 1334 is used to connect correspondingly to the first feed line 1331 and the second feed line 1332, to output a first feed signal to the first feed line 1331, and to output a second feed signal to the second feed line 1332. Phases of the first feed signal and the second feed signal may be the same or different. For instance, in this embodiment, the phases of the first feed signal and the second feed signal may differ by 90° or −90°. In this way, circularly polarized waves can be excited in the radiation unit 11. The signal receiving end RX is used to connect to the receiver 160 in the signal transceiver, the signal transmitting end TX is used to connect to the transmitter 150 in the signal transceiver.

An extending direction of the first feed line 1331 in the feeding layer 133 does not completely overlap with an extending direction of the corresponding second feed line 1332 in the feeding layer 133. The first feed line 1331 is used to generate a first polarized wave, and the second feed line 1332 is used to generate a second polarized wave. For example, in this embodiment, on the feeding layer 133, the first feed line 1331 extends in a first direction, and the second feed line 1332 extends in a second direction, the first direction is a direction away from the phase coupler 1334, the second direction is a direction away from the first feed line 1331, and the first direction and the second direction are perpendicular. In addition, when the phase difference between the first feed signal and the second feed signal is 90°, the first feed line 1331 and the second feed line 1332 can cooperatively excite a dual circular polarization signal, which is beneficial for communication with the low-orbit satellite. Furthermore, when a radiation pattern of the signal transmitted by the signal receiving end RX and a radiation pattern of the signal transmitted by the signal transmitting end TX are circular polarization patterns opposite to each other, the antenna array 10 can also realize simultaneous signal reception and transmission based on dual circular polarization waves through different radiation units 11.

More specifically, the first feed line 1331 can include a first feed section (not labeled in the figures), a second feed section (not labeled in the figures), and a third feed section (not labeled in the figures). A first end of the first feed section is connected to the first signal feeding end F1, a second end of the first feed section extends along the first direction and is connected to a first end of the second feed section, a second end of the second feed section extends along a direction opposite to the second direction and is connected to a first end of the third feed section, a second end of the third feed section extends along the first direction. The second feed line 1332 can include a fourth feed section (not labeled in the figures) and a fifth feed section (not labeled in the figures). A first end of the fourth feed section is connected to the second signal feeding end F2, a second end of the fourth feed section extends along the first direction and is connected to a first end of the fifth feed section, a second end of the fifth feed section extends along the second direction. Along the projection direction of the Z-axis of the antenna array 10, the projection of the first coupling slot 1311 and the projection of the corresponding third feed section of the first feed line 1331 are perpendicular to each other, and the projection of the second coupling slot 1312 and the projection of the corresponding fifth feed section of the second feed line 1332 are perpendicular to each other.

It can be understood that a length of the first feed line 1331 is a same with a length of the second feed line 1332.

The ground layer 135 is arranged on a side of the second cavity layer 134 away from the feeding layer 133. Understandably, the ground layer 135 may be a metal coating arranged on a printed circuit board. The metal coating can be arranged on a side of the ground layer 135 away from the second cavity layer 134. In the embodiment, the coupling layer 131, the first cavity layer 132, the feeding layer 133, the second cavity layer 134, and the ground layer 135 are each provided with through holes 1312 (not labeled in the figures), the through holes of each layer on the feeding module 130 are connected in sequence, and finally connected to the metal coating on the ground layer 135 to be grounded.

Referring to FIG. 4, in the embodiment, the first feed line 1331 is connected to the first signal feeding end F1 of the phase coupler 1334 through a metal connecting piece. The second feed line 1332 is connected to the second signal feeding end F2 of the phase coupler 1334 through a metal connecting piece. The feeding layer 133, the second cavity layer 134, and the ground layer 135 may be provided with a first connection hole and a second connection hole (not shown in the figures), so that the signal receiving end RX and the signal transmitting end TX of the phase coupler 1334 pass through the feeding layer 133, the second cavity layer 134, and the ground layer 135 through the first connection hole and the second connection hole respectively, so as to be connected to the transmitter 150 and the receiver 160 (see FIG. 36) in the signal transceiver. In other embodiments, the through hole, the first connection hole, and the second connection hole may also be replaced by a feeding probe, the present application does not limit the manner in which the antenna array 10 realizes electrical connection in the multi-layer structure.

Referring to FIG. 3 again, in some embodiments, the feeding module 130 further includes a first dielectric body 136, a second dielectric body 137, a third dielectric body 138, and a fourth dielectric body 139. The first dielectric body 136 is arranged between the coupling layer 131 and the first cavity layer 132, the second dielectric body 137 is arranged between the first cavity layer 132 and the feeding layer 133, the third dielectric body 138 is arranged between the feeding layer 133 and the second cavity layer 134, the fourth dielectric body 139 is arranged between the second cavity layer 134 and the ground layer 135. The first dielectric body 136, the second dielectric body 137, the third dielectric body 138, and the fourth dielectric body 139 may also be provided with the through hole, the first connection hole, and the second connection. It can be understood that the first dielectric body 136, the second dielectric body 137, the third dielectric body 138, and the fourth dielectric body 139 can be made of a material with a dielectric constant of about 2.4.

It should be known that the antenna array 10 is also connected to the phase modulation module (not shown in the figures). The phase modulation module is used to adjust phases of the transmitting signal and the receiving signal of the antenna array 10 to achieve high-efficiency communication between the device where the antenna array 10 is applied in and the low-orbit satellite through beam forming technology. For instance, the phase modulation module may include a control unit, a combiner, an attenuator, a power amplifier, a low-noise amplifier, etc. this application is not limited to a specific circuit structure of the phase modulation module.

In the embodiment, a working principle of the antenna array 10 is roughly as follows:

When the radiation unit 11 shown in FIG. 2 is used to transmit signals, the transmitter 150 in the signal transceiver feeds radio frequency signals to the first feed line 1331 and the second feed line 1332 through the signal transmitting end TX. Furthermore, since the extension directions of the first feed line 1331 and the second feed line 1332 are perpendicular to each other, a current path flowing through the first feed line 1331 and a current path flowing through the second feed line 1332 are orthogonal to each other. After the first feed line 1331 and the second feed line 1332 receive the feed signal through the first signal feed end F1 and the second signal feed end F2 respectively, in the Z-axis projection direction of the antenna array 10, the first feed line 1331 and the second feed line 1332 stagger each other at an angle. In this way, the first feed line 1331 and the second feed line 1332 can generate a first polarized wave and a second polarized wave respectively, especially generating horizontally polarized waves and vertically polarized waves. Additionally, through the phase coupler 1334, the first polarized wave generated by the first feed line 1331 and the second polarized wave generated by the second feed line 1332 are simultaneously coupled and fed to the first radiator 1111 through the first coupling slots 1311 and the second coupling slots 1312 on the coupling layer 131, causing the first radiator 1111 to transmit a left-hand circularly polarized wave or a right-hand circularly polarized wave outward. In some embodiments, an operating frequency band when the antenna array 10 is used to transmit signals may be 14 GHz-14.5 GHz.

When the radiation unit 11 shown in FIG. 2 is used to receive signals, the first radiator 1111 receives electromagnetic waves from the outside and converts them into electrical signals, the first radiator 1111 couples the electrical signals to the first feed line 1331 and the second feed line 1332 through the first coupling slot 1311 and the second coupling slot 1312, the first feed line 1331 and the second feed line 1332 further feed back the electrical signals to the receiver 160 in the signal transceiver through the phase coupler 1334. Since the first coupling slot 1311 and the second coupling slot 1312 are perpendicular to and spaced apart from each other, the extension directions of the first feed line 1331 and the second feed line 1332 are perpendicular to each other, so the first feed line 1331 can couple to generate the first polarized waves, and the second feed line 1332 can couple to generate the second polarized waves, the polarization directions of the first polarized waves and the second polarized waves are perpendicular to each other. Therefore, the current path of the current signal generated by the first feed line 1331 according to the first polarized wave and the current path of the current signal generated by the second feed line 1332 according to the second polarized wave are orthogonal to each other. In this way, the first feed line 1331 and the second feed line 1332 transmit the generated current signal to the signal receiving end RX through the first signal feeding end F1 and the second signal feeding end F2 respectively, and then transmit the received current signal to the receiver 160 in the signal transceiver through the signal receiving end RX to realize the reception of the antenna signal. In some embodiments, an operating frequency band when the antenna array 10 is used to receive signals may be 10.7 GHZ-12.5 GHz.

In some embodiments, the radiation field type of the signal transmitted by the signal receiving end RX of the phase coupler 1334 and the radiation field type of the signal transmitted by the signal transmitting end TX are mutually opposite circular polarization field types. That is to say, the radiation unit 11 may transmit one of the left-hand circularly polarized wave or the right-hand circularly polarized wave when transmitting a signal, and the radiating unit 11 may transmit the other of the left-hand circularly polarized wave or the right-hand circularly polarized wave when receiving a signal. In some other embodiments, a radio frequency switch can also be set to control the radiation unit 11 to transmit the left-hand circular polarized wave or the right-hand circular polarized wave when receiving a signal, and to control the radiation unit 11 to transmit the left-hand circular polarized wave or the right-hand circularly polarized wave when transmitting a signal.

It can be understood that since the antenna array 10 includes a plurality of radiating units 11 (for example, 1024 radiating units 11), in some embodiments, the phase modulation module can control some of the radiating units 11 in the antenna array 10 to transmit signals, at the same time, other radiating units 11 in the antenna array 10 are controlled to receive signals. In this way, the antenna array 10 can simultaneously receive and transmit signals from low-orbit satellites, thereby improving communication efficiency with low-orbit satellites.

It can be understood that in each radiating unit 11 of the antenna array 10, the projected area of the first radiator 1111 in the Z-axis direction of the antenna array 10 completely covers the projected area of the first coupling slot 1311 and the second coupling slot 1312 in the Z-axis direction of the antenna array 10. So that the energy of the first feed line 1331 and the second feed line 1332 can be coupled to the first radiator 1111 as much as possible.

Referring to FIG. 3 again, in some embodiments, the antenna array 10 further includes a protective layer 120. The protective layer 120 is disposed on the side of the first radiation layer 111 away from the first dielectric layer 112 to protect the antenna array 10 from an influence of sunlight, rain, and dust, so as to improve the working stability of the antenna array 10. In this embodiment, the protective layer 120 is also provided with a protective cavity 121 corresponding to the first radiator 1111. For example, the protective cavity 121 may be formed by an inward recess of a side of the protective layer 120 closes to the first radiator 1111, and the protective cavity 121 may be substantially cylindrical. In this way, the weight of the antenna array 10 can be reduced.

Further, in the antenna array 10, the first radiating layer 111, the first dielectric layer 112, the first cavity layer 132, the second cavity layer 134, the first dielectric body 136, the second dielectric body 137, the third dielectric body 138, and the fourth dielectric body 139 can also define through holes at positions that do not correspond to the first radiator 1111. In this way, the weight of the antenna array 10 can be further reduced.

It can be understood that in the antenna array 10, each adjacent two-layer structure can be connected by adhesive, this application does not limit the specific type of adhesive.

As shown in FIG. 3 and FIG. 4, in the first specific example of the embodiment of the present application, one end of the first coupling slot 1311 and the second coupling slot 1312 is at least formed with a port shape. An angle formed by the port shape at one end of the first coupling slot 1311 is oriented toward the first coupling slot 1311, and the first coupling slot 1311 is in the shape of a unidirectional arrow as a whole.

Specifically, as shown in FIG. 5, one end of the first coupling slot 1311a is formed with a port shape, the end of the first coupling slot 1311a formed with the port shape is close to the second coupling slot 1312, the port shape is formed with an angle, and the angle is toward the first coupling slot 1311a. No port shape with an angle is formed at both ends of the second coupling slot 1312. That is, in this example, the port shape is only formed at one end of the first coupling slot 1311a.

Specifically, the first coupling slot 1311a includes a first main slot 13110a which is narrow and long, a first sub-slot 13111a and a second sub-slot 13112a which are connected to the first main slot 13110a are formed at both ends of the first main slot 13110a, respectively. The first sub-slot 13111a is close to the second coupling slot 1312 and an angle is formed as a whole, and the angle is toward the first main slot 13110a. The second sub-slot 13112a is vertically connected to the first main slot 13110a, so that the first coupling slot 1311a is in the shape of a unidirectional arrow as a whole. The second coupling slot 1312a includes a second main slot 13120a which is narrow and long, a third sub-slot 13121a and a fourth sub-slot 13122a which are connected to the second main slot 13120a are respectively formed at both ends of the second main slot 13120a, the third sub-slot 13121a and the fourth sub-slot 13122a are vertically connected to the second main slot 13120a, so that the second coupling slot 1312a is H-shaped as a whole. An extension line of the first main slot 13110a of the first coupling slot 1311a and the second main slot 13120a of the second coupling slot 1312a are perpendicular to each other.

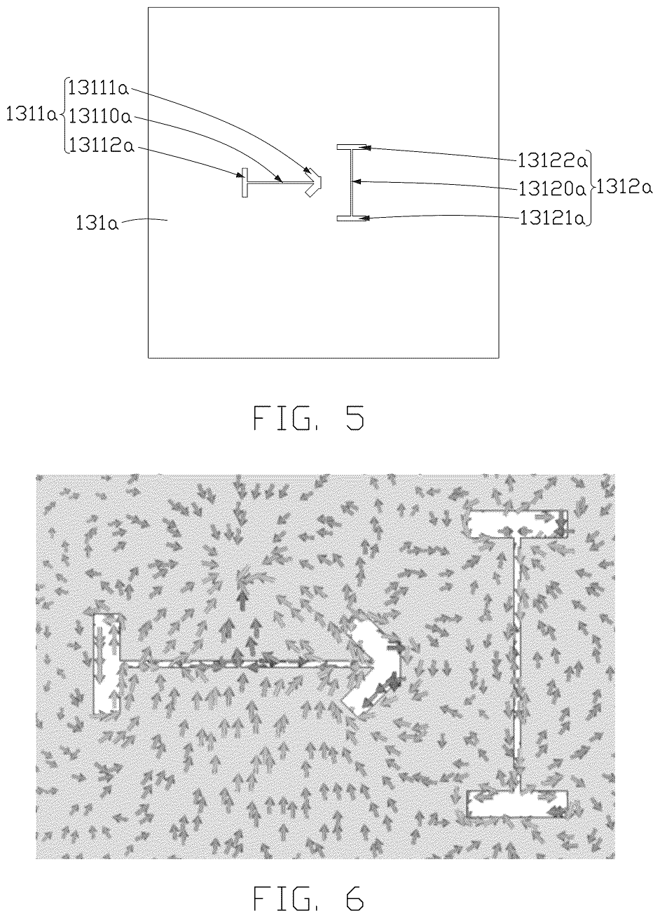

Referring to FIG. 6, FIG. 6 is a schematic diagram of current paths of the coupling layer 131a in the example of FIG. 5. According to FIG. 6, the current path and direction of the current on the coupling layer 131a are changed by the unidirectional arrow shape of the first coupling slot 1311a, the current is concentrated near the port shape formed by the first coupling slot 1311a, thereby reducing the coupling interference between the first feed line 1331 and the second feed line 1332, improving the isolation between the first feed line 1331 and the second feed line 1332, and thus reducing the interference effect of the antenna array 10.

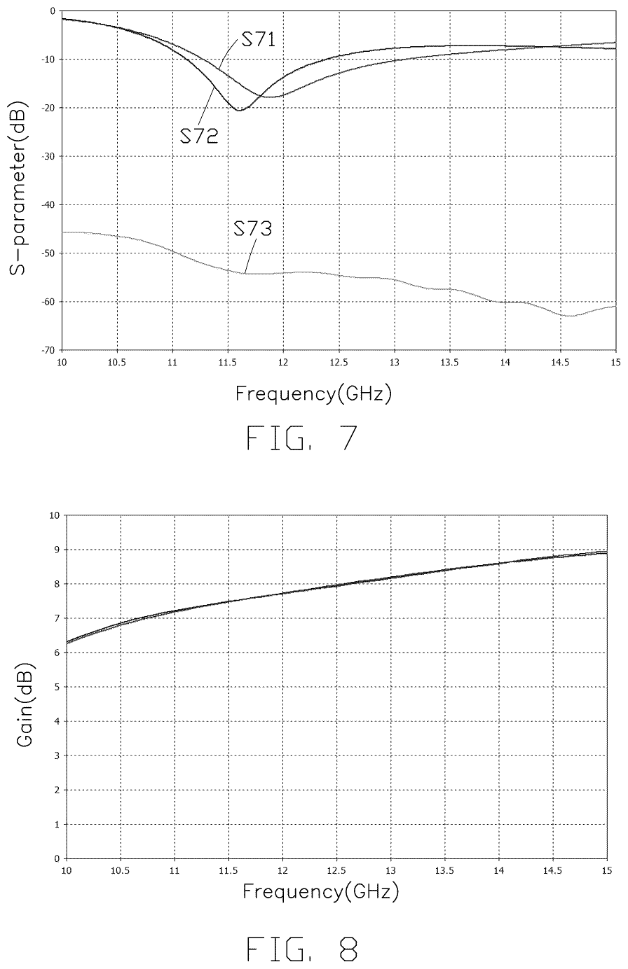

Referring to FIG. 7, FIG. 7 is a scattering parameter (S-parameter) curve diagram of the radiation unit 11 using FIG. 5 as a coupling layer. Curve S71 represents a S11 value of the signal receiving end RX when the radiation unit 11 is used to receive signals; curve S72 represents a S11 value of the signal transmitting end TX when the radiation unit 11 is used to transmit signals; curve S73 represents a S12 value between the signal receiving end RX and the signal transmitting end TX. As can be seen from FIG. 7, the radiation unit 11 has a good reflection coefficient when transmitting or receiving signals, and the S12 value between the signal receiving end RX and the signal transmitting end TX of the radiation unit 11 can reach below −50 dB, which can effectively reduce the coupling effect between the first feed line 1331 and the second feed line 1332, so that the first feed line 1331 and the second feed line 1332 have better isolation.

Referring to FIG. 8, FIG. 8 is an antenna gain curve diagram of the radiation unit 11 using FIG. 5 as a coupling layer. A gain value of the signal transmitting end TX when the radiation unit 11 is used to transmit signals is substantially coincident with a gain value of the signal receiving end RX when the radiation unit 11 is used to receive signal s. As can be seen from FIG. 8, the radiation unit 11 of this example has a high antenna gain, which meets the antenna working requirements. The gain value of the signal transmitting end TX when the radiation unit 11 is used to transmit signals is substantially the same as the gain value of the signal receiving end RX when the radiation unit 11 is used to receive signals.

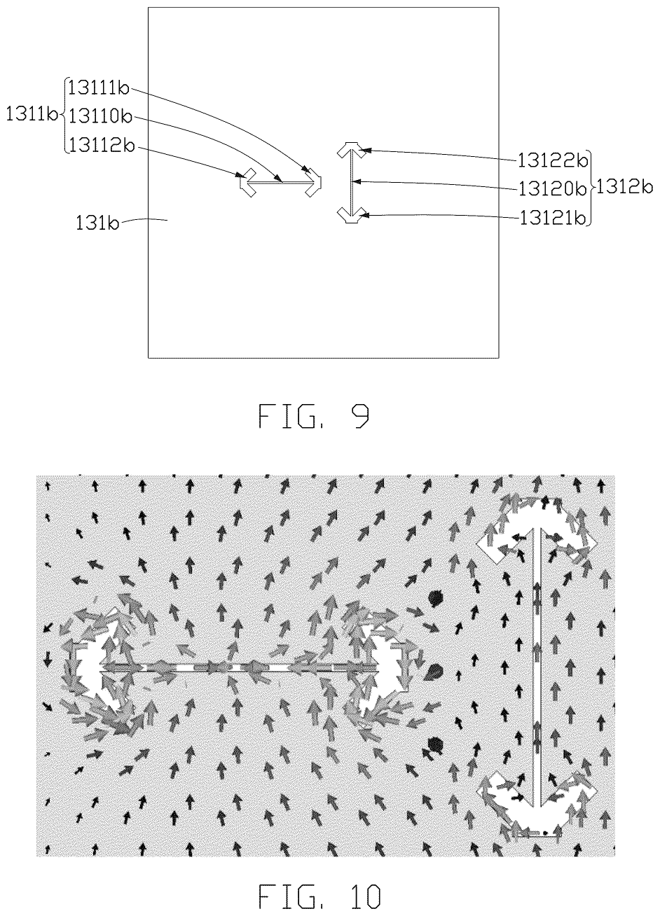

Referring to FIG. 9, FIG. 9 shows a schematic diagram of the structure of the coupling layer 131b of a second specific example of the embodiment. As shown in FIG. 9, both ends of the first coupling slot 1311 and the second coupling slot 1312 are formed with the port shapes, and the port shapes form an angle, that is, the port shapes are formed at all ends of the first coupling slot 1311 and the second coupling slot 1312. The angle formed by the port shapes at both ends of the first coupling slot 1311 is oriented toward the first coupling slot 1311, and the angle formed by the port shapes at both ends of the second coupling slot 1312 is oriented toward the second coupling slot 1312. Thus, the first coupling slot 1311 is in the shape of a bidirectional arrow as a whole, and the second coupling slot 1312 is also in the shape of a bidirectional arrow as a whole.

Specifically, the first coupling slot 1311b includes a first main slot 13110b which is narrow and long, a first sub-slot 13111b and a second sub-slot 13112b which are connected to the first main slot 13110b are respectively formed at both ends of the first main slot 13110b, the first sub-slot 13111b and the second sub-slot 13112b are formed with an angle as a whole, and the angle is toward the first main slot 13110b, the first sub-slot 13111b and the second sub-slot 13112b are symmetrically arranged along a center of the first main slot 13110b. The second coupling slot 1312b includes a second main slot 13120b which is narrow and long, a third sub-slot 13121b and a fourth sub-slot 13122b that are connected to the second main slot 13120b are respectively formed at both ends of the second main slot 13120b, the third sub-slot 13121b and the fourth sub-slot 13122b are formed with an angle as a whole, and the angle is toward the second main slot 13120b, the third sub-slot 13121b and the fourth sub-slot 13122b are symmetrically arranged along a center of the second main slot 13120b. Therefore, the first coupling slot 1311b and the second coupling slot 1312b are in the shape of a bidirectional arrow as a whole.

An extension line of the first main slot 13110b of the first coupling slot 1311b and the second main slot 13120b of the second coupling slot 1312b are perpendicular to each other. An intersection point of the extension line of the first main slot 13110b of the first coupling slot 1311b and the second main slot 13120b of the second coupling slot 1312b may be a midpoint of the second main slot 13120b. Of course, it is understood that, in some other embodiments, the first sub-slot 13111b and the second sub-slot 13112b may not be symmetrically arranged along the center of the first main slot 13110b, and the third sub-slot 13121b and the fourth sub-slot 13122b may not be symmetrically arranged along the center of the second main slot 13120b.

Referring to FIG. 10, FIG. 10 is a schematic diagram of current paths of the coupling layer 131b in the example of FIG. 9. According to FIG. 10, the current path and direction of the current on the coupling layer 131b are changed by the bidirectional arrow shape of the first coupling slot 1311b and the second coupling slot 1312b, the current is concentrated near the port shape formed by the first coupling slot 1311b and the second coupling slot 1312b, thereby reducing the coupling interference between the first feed line 1331 and the second feed line 1332, improving the isolation between the first feed line 1331 and the second feed line 1332, and thus reducing the interference effect of the antenna array 10.

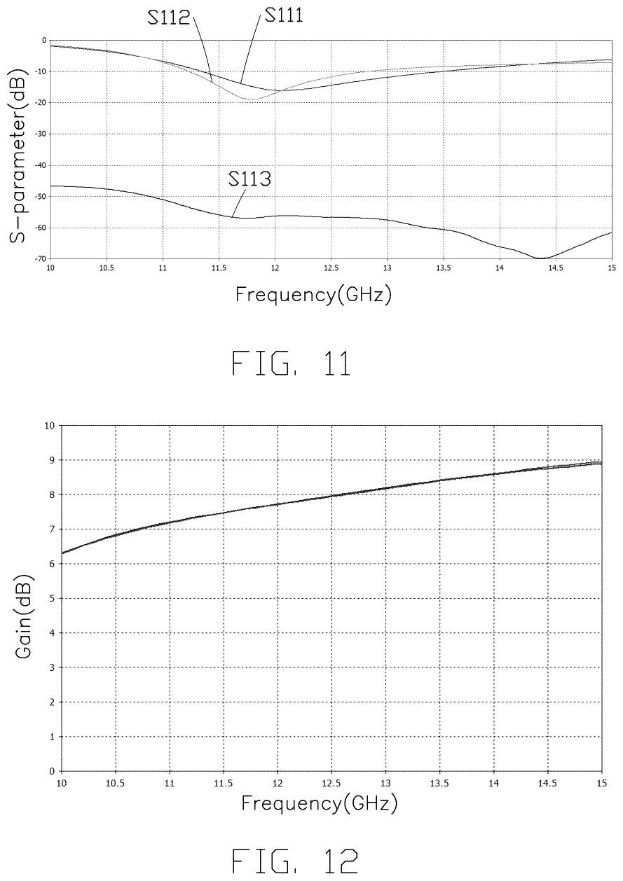

Referring to FIG. 11, FIG. 11 is a scattering parameter (S-parameter) curve diagram of the radiation unit 11 using FIG. 9 as a coupling layer. Curve S111 represents a S11 value of the signal receiving end RX when the radiation unit 11 is used to receive signals; curve S112 represents a S11 value of the signal transmitting end TX when the radiation unit 11 is used to transmit signals; curve S113 represents a S12 value between the signal receiving end RX and the signal transmitting end TX. As can be seen from FIG. 11, the radiation unit 11 has a good reflection coefficient when transmitting or receiving signals, and the S12 value between the signal receiving end RX and the signal transmitting end TX of the radiation unit 11 can reach below −50 dB, which can effectively reduce the coupling effect between the first feed line 1331 and the second feed line 1332, so that the first feed line 1331 and the second feed line 1332 have better isolation.

Referring to FIG. 12, FIG. 12 is an antenna gain curve diagram of the radiation unit 11 using FIG. 9 as a coupling layer. A gain value of the signal transmitting end TX when the radiation unit 11 is used to transmit signals is substantially coincident with a gain value of the signal receiving end RX when the radiation unit 11 is used to receive signal s. As can be seen from FIG. 12, the radiation unit 11 of this example has a high antenna gain, which meets the antenna working requirements.

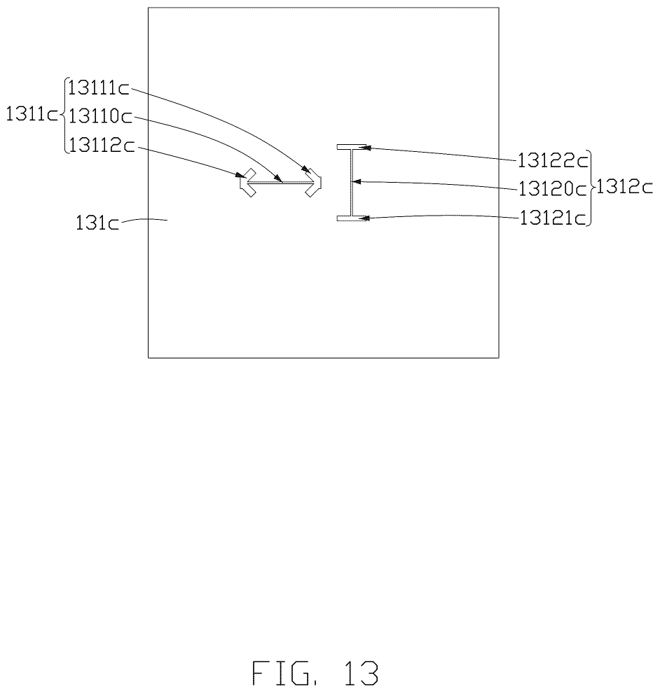

Referring to FIG. 13, FIG. 13 shows a schematic diagram of the structure of the coupling layer 131c of a second specific example of the embodiment. As shown in FIG. 13, both ends of the first coupling slot 1311c are formed with the port shapes, and the port shapes form an angle, the angle is oriented toward the first coupling slot 1311c. Both ends of the second coupling slot 1312c do not form the port shapes with an angle.

Specifically, the first coupling slot 1311c includes a first main slot 13110c which is narrow and long, a first sub-slot 13111c and a second sub-slot 13112c which are connected to the first main slot 13110c are respectively formed at both ends of the first main slot 13110c, the first sub-slot 13111c and the second sub-slot 13112c are formed with an angle as a whole, and the angle is toward the first main slot 13110c, the first sub-slot 13111c and the second sub-slot 13112c are symmetrically arranged along a center of the first main slot 13110c, so the first coupling slot 1311c is in the shape of the bidirectional arrow as a whole. The second coupling slot 1312c includes a second main slot 13120c which is narrow and long, a third sub-slot 13121c and a fourth sub-slot 13122c that are connected to the second main slot 13120c are respectively formed at both ends of the second main slot 13120c, the third sub-slot 13121c and the fourth sub-slot 13122c are both vertically connected to the second main slot 13120c, so that the second coupling slot 1312c is H-shaped as a whole. An extension line of the first main slot 13110c of the first coupling slot 1311c and the second main slot 13120c of the second coupling slot 1312c are perpendicular to each other.

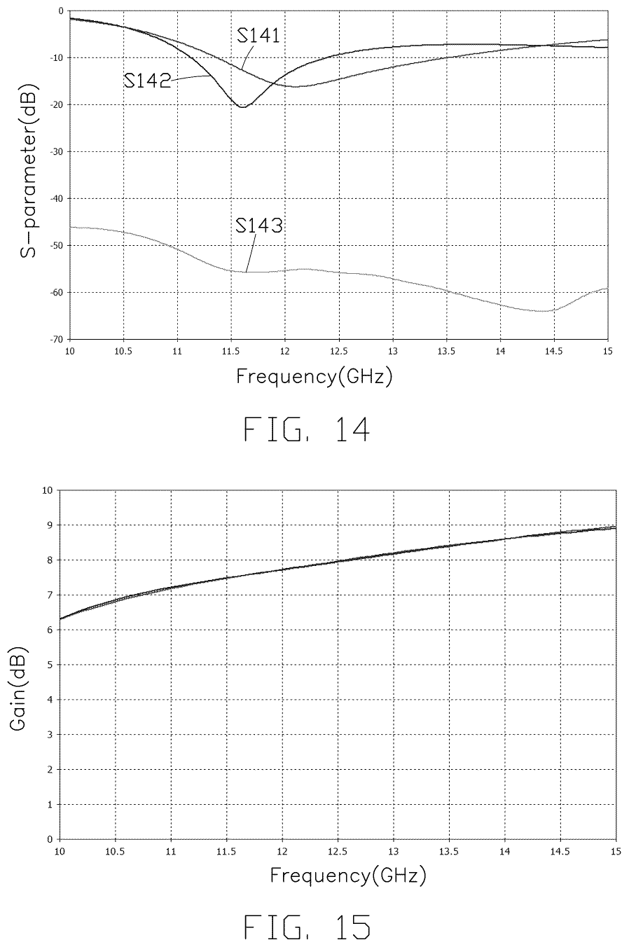

Referring to FIG. 14, FIG. 14 is a scattering parameter (S-parameter) curve diagram of the radiation unit 11 using FIG. 13 as a coupling layer. Curve S141 represents a S11 value of the signal receiving end RX when the radiation unit 11 is used to receive signals; curve S142 represents a S11 value of the signal transmitting end TX when the radiation unit 11 is used to transmit signals; curve S143 represents a S12 value between the signal receiving end RX and the signal transmitting end TX. As can be seen from FIG. 14, the radiation unit 11 has a good reflection coefficient when transmitting or receiving signals, and the S12 value between the signal receiving end RX and the signal transmitting end TX of the radiation unit 11 can reach below −50 dB, which can effectively reduce the coupling effect between the first feed line 1331 and the second feed line 1332, so that the first feed line 1331 and the second feed line 1332 have better isolation.

Referring to FIG. 15, FIG. 15 is an antenna gain curve diagram of the radiation unit 11 using FIG. 13 as a coupling layer. A gain value of the signal transmitting end TX when the radiation unit 11 is used to transmit signals is substantially coincident with a gain value of the signal receiving end RX when the radiation unit 11 is used to receive signals. As can be seen from FIG. 15, the radiation unit 11 of this example has a high antenna gain, which meets the antenna working requirements.

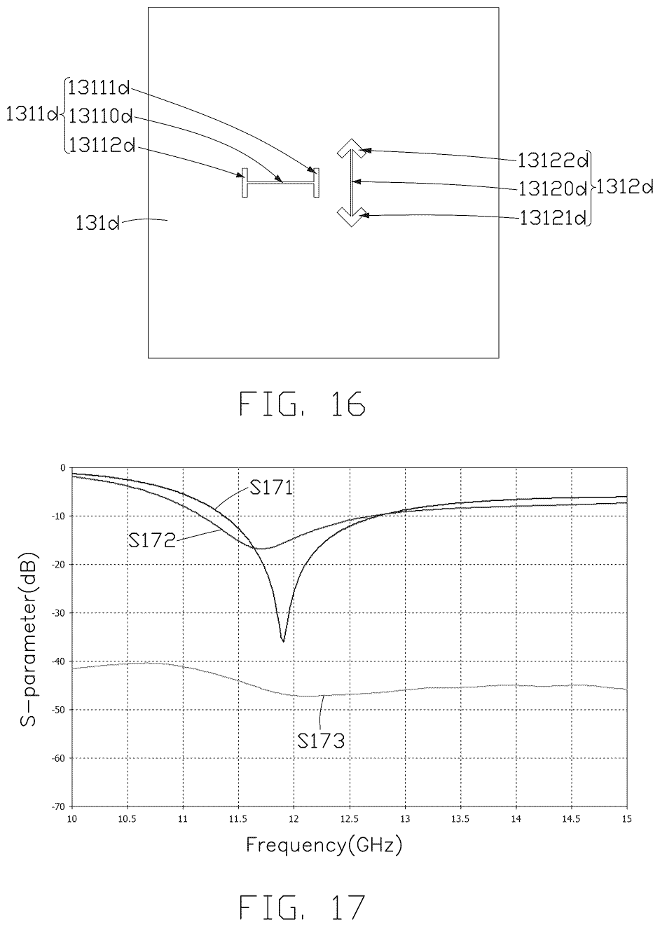

Referring to FIG. 16, FIG. 16 shows a schematic diagram of the structure of the coupling layer 131d of a fourth specific example of the embodiment. As shown in FIG. 16, both ends of the first coupling slot 1311d do not form the port shapes with an angle. Both ends of the second coupling slot 1312d are formed with the port shapes, and the port shapes form an angle, the angle is oriented toward the second coupling slot 1312d.

Specifically, the first coupling slot 1311d includes a first main slot 13110d which is narrow and long, a first sub-slot 13111d and a second sub-slot 13112d which are connected to the first main slot 13110d are respectively formed at both ends of the first main slot 13110d, the first sub-slot 13111d and the second sub-slot 13112d are both vertically connected to the first main slot 13110d, so that the first coupling slot 1311d is H-shaped as a whole. The second coupling slot 1312d includes a second main slot 13120d which is narrow and long, a third sub-slot 13121d and a fourth sub-slot 13122d that are connected to the second main slot 13120d are respectively formed at both ends of the second main slot 13120d, the third sub-slot 13121d and the fourth sub-slot 13122d are formed with an angle as a whole, and the angle is toward the second main slot 13120d, the third sub-slot 13121d and the fourth sub-slot 13122d are symmetrically arranged along a center of the second main slot 13120d so the second coupling slot 1312d is in the shape of the bidirectional arrow as a whole. An extension line of the first main slot 13110d of the first coupling slot 1311d and the second main slot 13120d of the second coupling slot 1312d are perpendicular to each other.

Referring to FIG. 17, FIG. 17 is a scattering parameter (S-parameter) curve diagram of the radiation unit 11 using FIG. 16 as a coupling layer. Curve S171 represents a S11 value of the signal receiving end RX when the radiation unit 11 is used to receive signals; curve S172 represents a S11 value of the signal transmitting end TX when the radiation unit 11 is used to transmit signals; curve S173 represents a S12 value between the signal receiving end RX and the signal transmitting end TX. As can be seen from FIG. 17, the radiation unit 11 has a good reflection coefficient when transmitting or receiving signals, and the S12 value between the signal receiving end RX and the signal transmitting end TX of the radiation unit 11 can reach below −40 dB, which can effectively reduce the coupling effect between the first feed line 1331 and the second feed line 1332, so that the first feed line 1331 and the second feed line 1332 have better isolation.

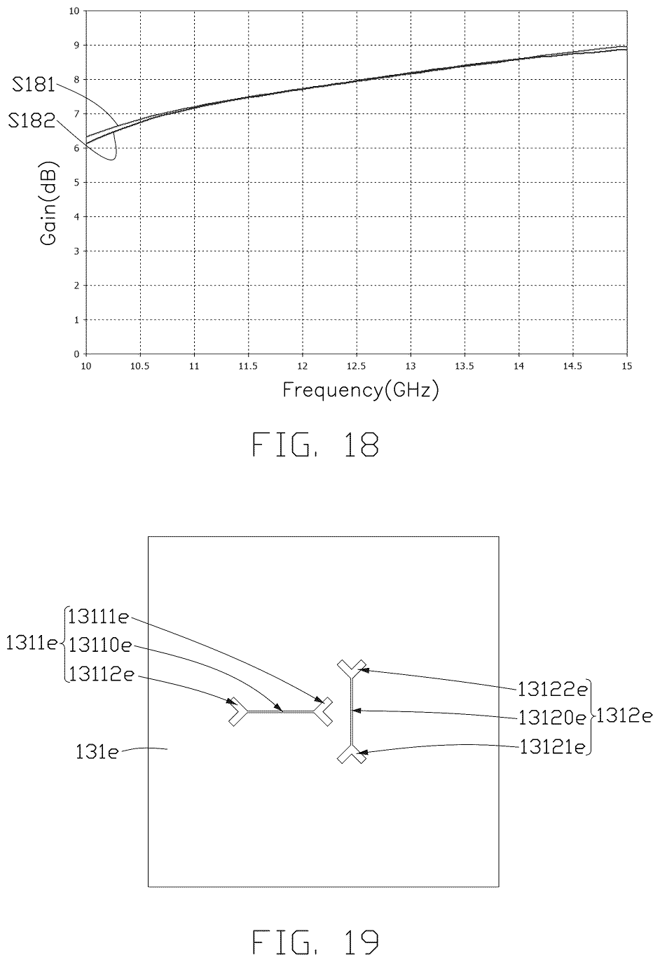

Referring to FIG. 18, FIG. 18 is an antenna gain curve diagram of the radiation unit 11 using FIG. 16 as a coupling layer. Curve S181 represents a gain value of the signal transmitting end TX when the radiation unit 11 is used to transmit signals; curve S182 represents a gain value of the signal receiving end RX when the radiation unit 11 is used to receive signals. As can be seen from FIG. 18, the radiation unit 11 of this example has a high antenna gain, which meets the antenna working requirements.

Referring to FIG. 19, FIG. 19 shows a schematic diagram of the structure of the coupling layer 131e of a fifth specific example of the embodiment. As shown in FIG. 19, both ends of the first coupling slot 1311e are formed with the port shapes, and the port shapes form an angle, the angle is oriented toward the first coupling slot 1311e. Both ends of the second coupling slot 1312e are formed with the port shapes, and the port shapes form an angle, the angle is facing away from the second coupling slot 1312e.

Specifically, the first coupling slot 1311e includes a first main slot 13110e which is narrow and long, a first sub-slot 13111e and a second sub-slot 13112e which are connected to the first main slot 13110e are respectively formed at both ends of the first main slot 13110e, the first sub-slot 13111e and the second sub-slot 13112e are formed with an angle as a whole, and the angle is facing away from the first main slot 13110e, the first sub-slot 13111e and the second sub-slot 13112e are symmetrically arranged along a center of the first main slot 13110e, so both ends of the first coupling slot 1311e are formed with the port shape. The second coupling slot 1312e includes a second main slot 13120e which is narrow and long, a third sub-slot 13121e and a fourth sub-slot 13122e that are connected to the second main slot 13120e are respectively formed at both ends of the second main slot 13120e, the third sub-slot 13121e and the fourth sub-slot 13122e are formed with an angle as a whole, and the angle is facing away from the second main slot 13120e, the third sub-slot 13121e and the fourth sub-slot 13122e are symmetrically arranged along a center of the second main slot 13120e, so both ends of the second coupling slot 1312e are formed with the port shape. Of course, it is understood that, in some other embodiments, the first sub-slot 13111e and the second sub-slot 13112e may not be symmetrically arranged along the center of the first main slot 13110e, and the third sub-slot 13121e and the fourth sub-slot 13122e may not be symmetrically arranged along the center of the second main slot 13120e. An extension line of the first main slot 13110e of the first coupling slot 1311e and the second main slot 13120e of the second coupling slot 1312e are perpendicular to each other.

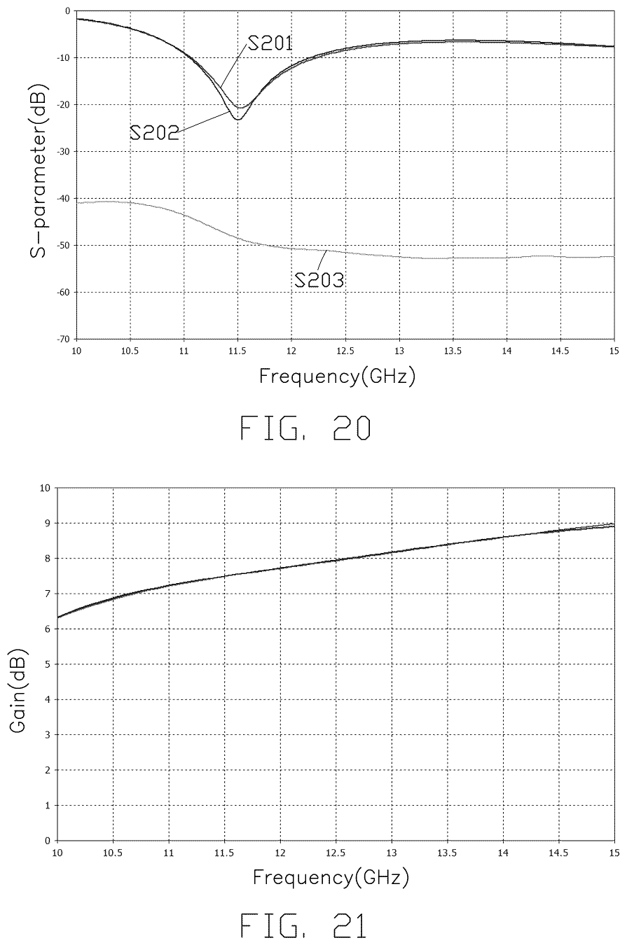

Referring to FIG. 20, FIG. 20 is a scattering parameter (S-parameter) curve diagram of the radiation unit 11 using FIG. 19 as a coupling layer. Curve S191 represents a S11 value of the signal receiving end RX when the radiation unit 11 is used to receive signals; curve S192 represents a S11 value of the signal transmitting end TX when the radiation unit 11 is used to transmit signals; curve S193 represents a S12 value between the signal receiving end RX and the signal transmitting end TX. As can be seen from FIG. 20, the radiation unit 11 has a good reflection coefficient when transmitting or receiving signals, and the S12 value between the signal receiving end RX and the signal transmitting end TX of the radiation unit 11 can reach below −40 dB, which can effectively reduce the coupling effect between the first feed line 1331 and the second feed line 1332, so that the first feed line 1331 and the second feed line 1332 have better isolation.

Referring to FIG. 21, FIG. 21 is an antenna gain curve diagram of the radiation unit 11 using FIG. 19 as a coupling layer. A gain value of the signal transmitting end TX when the radiation unit 11 is used to transmit signals is substantially coincident with a gain value of the signal receiving end RX when the radiation unit 11 is used to receive signals. As can be seen from FIG. 21, the radiation unit 11 of this example has a high antenna gain, which meets the antenna working requirements.

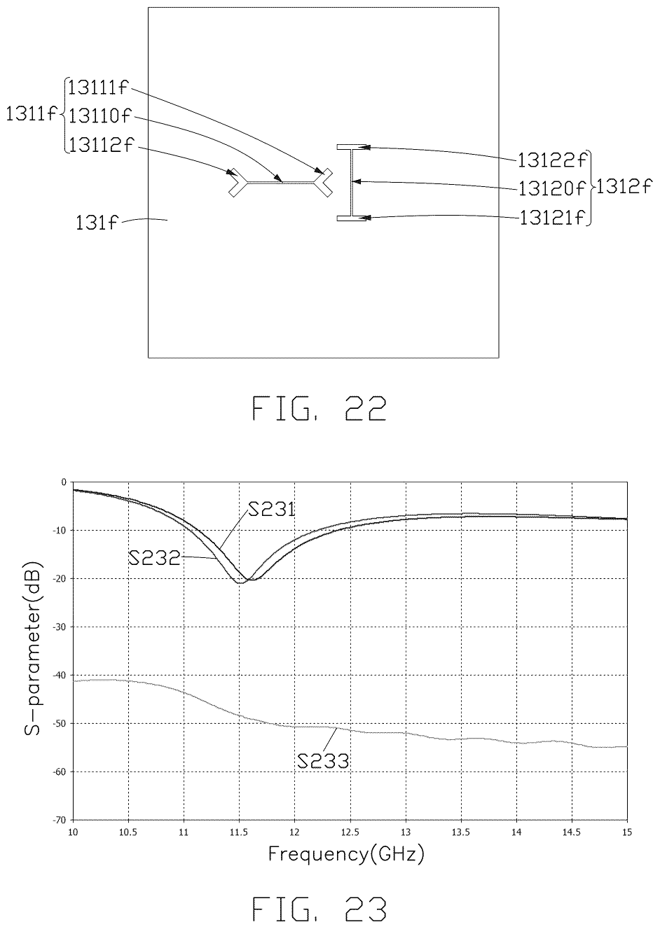

Referring to FIG. 22, FIG. 22 shows a schematic diagram of the structure of the coupling layer 131f of a sixth specific example of the embodiment. As shown in FIG. 22, both ends of the first coupling slot 1311f are formed with the port shapes, and the port shapes form an angle, the angle is facing away from the first coupling slot 1311f. Both ends of the second coupling slot 1312f do not form the port shapes with an angle.

Specifically, the first coupling slot 1311f includes a first main slot 13110f which is narrow and long, a first sub-slot 13111f and a second sub-slot 13112f which are connected to the first main slot 13110f are respectively formed at both ends of the first main slot 13110f, the first sub-slot 13111f and the second sub-slot 13112f are formed with an angle as a whole, and the angle is facing away from the first main slot 13110f, the first sub-slot 13111f and the second sub-slot 13112f are symmetrically arranged along a center of the first main slot 13110f, so both ends of the first coupling slot 1311f are formed with the port shape. The second coupling slot 1312f includes a second main slot 13120f which is narrow and long, a third sub-slot 13121f and a fourth sub-slot 13122f that are connected to the second main slot 13120f are respectively formed at both ends of the second main slot 13120f, the third sub-slot 13121f and the fourth sub-slot 13122f are both vertically connected to the second main slot 13120f, so that the second coupling slot 1312f is H-shaped as a whole. An extension line of the first main slot 13110f of the first coupling slot 1311f and the second main slot 13120f of the second coupling slot 1312f are perpendicular to each other.

Referring to FIG. 23, FIG. 23 is a scattering parameter (S-parameter) curve diagram of the radiation unit 11 using FIG. 22 as a coupling layer. Curve S231 represents a S11 value of the signal receiving end RX when the radiation unit 11 is used to receive signals; curve S232 represents a S11 value of the signal transmitting end TX when the radiation unit 11 is used to transmit signals; curve S233 represents a S12 value between the signal receiving end RX and the signal transmitting end TX. As can be seen from FIG. 23, the radiation unit 11 has a good reflection coefficient when transmitting or receiving signals, and the S12 value between the signal receiving end RX and the signal transmitting end TX of the radiation unit 11 can reach below −50 dB, which can effectively reduce the coupling effect between the first feed line 1331 and the second feed line 1332, so that the first feed line 1331 and the second feed line 1332 have better isolation.

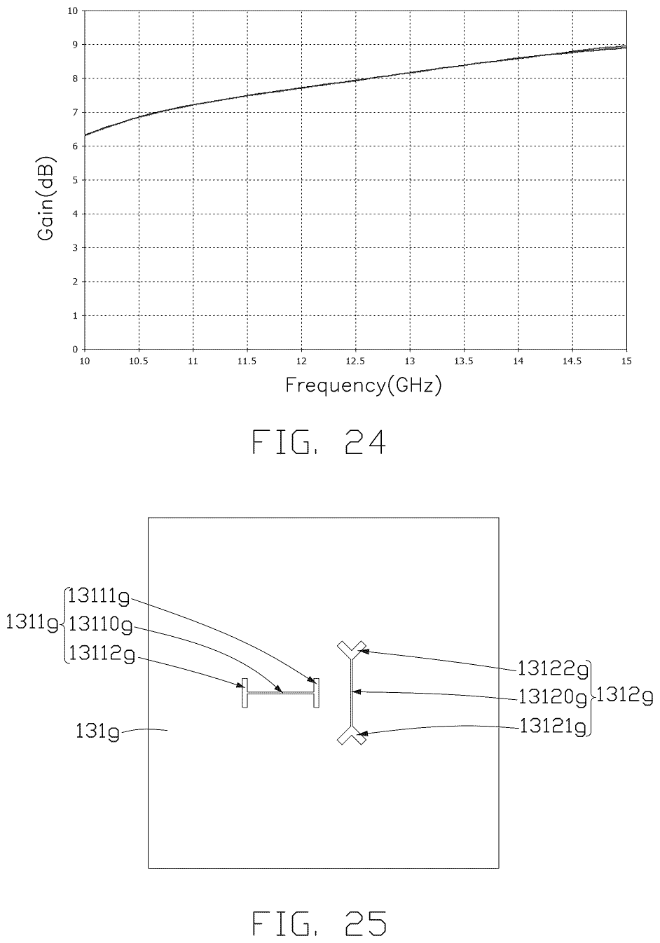

Referring to FIG. 24, FIG. 24 is an antenna gain curve diagram of the radiation unit 11 using FIG. 22 as a coupling layer. A gain value of the signal transmitting end TX when the radiation unit 11 is used to transmit signals is substantially coincident with a gain value of the signal receiving end RX when the radiation unit 11 is used to receive signals. As can be seen from FIG. 24, the radiation unit 11 of this example has a high antenna gain, which meets the antenna working requirements.

Referring to FIG. 25, FIG. 25 shows a schematic diagram of the structure of the coupling layer 131g of a seventh specific example of the embodiment. As shown in FIG. 25, both ends of the first coupling slot 1311g do not form the port shapes with an angle. Both ends of the second coupling slot 1312g are formed with the port shapes, and the port shapes form an angle, the angle is facing away from the second coupling slot 1312g.

Specifically, the first coupling slot 1311g includes a first main slot 13110g which is narrow and long, a first sub-slot 13111g and a second sub-slot 13112g which are connected to the first main slot 13110g are respectively formed at both ends of the first main slot 13110g, the first sub-slot 13111g and the second sub-slot 13112g are both vertically connected to the first main slot 13110g, so that the first coupling slot 1311g is H-shaped as a whole. The second coupling slot 1312g includes a second main slot 13120g which is narrow and long, a third sub-slot 13121g and a fourth sub-slot 13122g that are connected to the second main slot 13120g are respectively formed at both ends of the second main slot 13120g, the third sub-slot 13121g and the fourth sub-slot 13122g are formed with an angle as a whole, and the angle is facing away from the second main slot 13120g, the first sub-slot 13111g and the second sub-slot 13112g are symmetrically arranged along a center of the second main slot 13120g, so both ends of the second main slot 13120g are formed with the port shape. An extension line of the first main slot 13110g of the first coupling slot 1311g and the second main slot 13120g of the second coupling slot 1312g are perpendicular to each other.

Referring to FIG. 26, FIG. 26 is a scattering parameter (S-parameter) curve diagram of the radiation unit 11 using FIG. 25 as a coupling layer. Curve S261 represents a S11 value of the signal receiving end RX when the radiation unit 11 is used to receive signals; curve S262 represents a S11 value of the signal transmitting end TX when the radiation unit 11 is used to transmit signals; curve S263 represents a S12 value between the signal receiving end RX and the signal transmitting end TX. As can be seen from FIG. 26, the radiation unit 11 has a good reflection coefficient when transmitting or receiving signals, and the S12 value between the signal receiving end RX and the signal transmitting end TX of the radiation unit 11 can reach below −50 dB, which can effectively reduce the coupling effect between the first feed line 1331 and the second feed line 1332, so that the first feed line 1331 and the second feed line 1332 have better isolation.

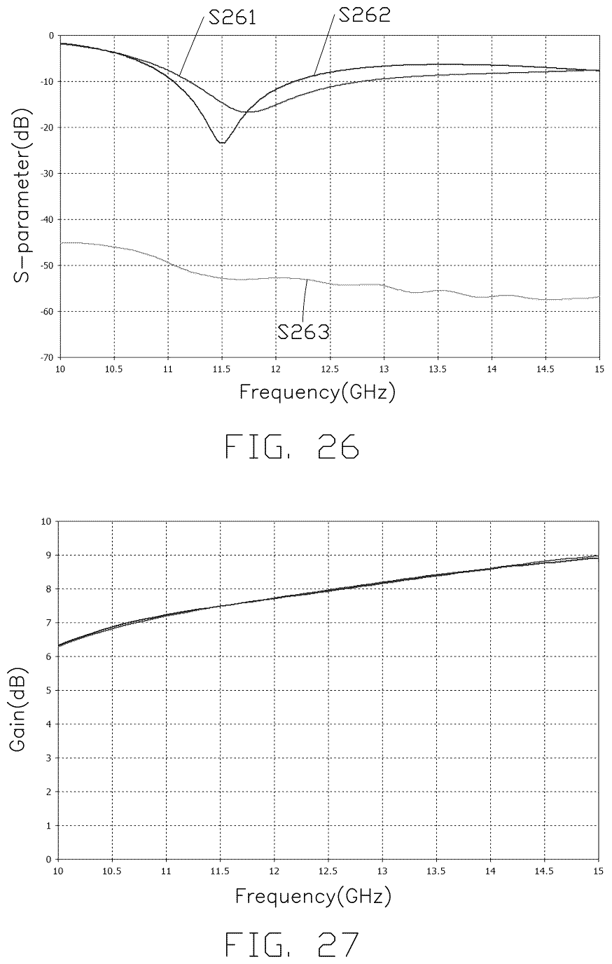

Referring to FIG. 27, FIG. 27 is an antenna gain curve diagram of the radiation unit 11 using FIG. 25 as a coupling layer. A gain value of the signal transmitting end TX when the radiation unit 11 is used to transmit signals is substantially coincident with a gain value of the signal receiving end RX when the radiation unit 11 is used to receive signals. As can be seen from FIG. 27, the radiation unit 11 of this example has a high antenna gain, which meets the antenna working requirements.

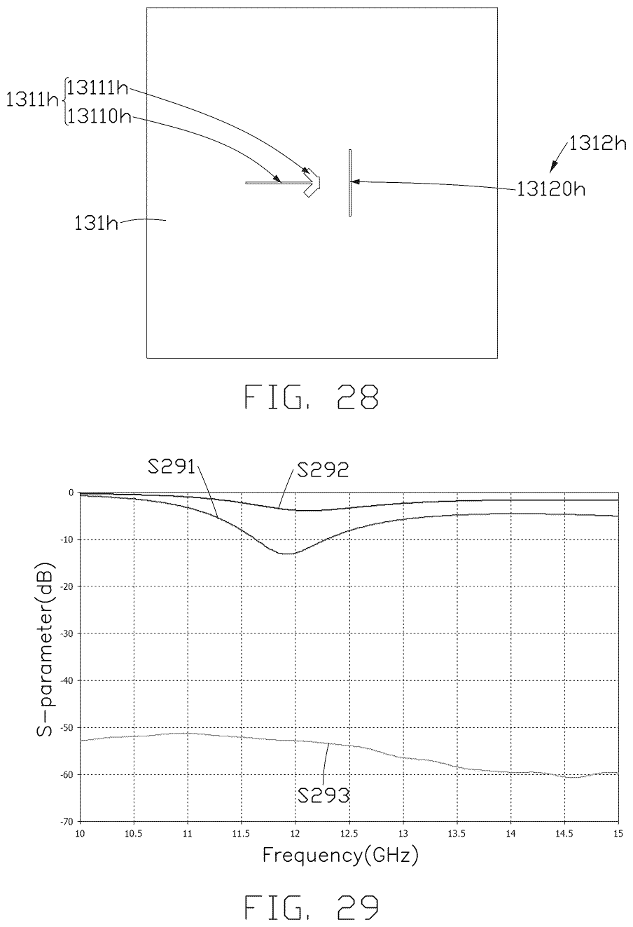

Referring to FIG. 28, FIG. 28 shows a schematic diagram of the structure of the coupling layer 131h of a seventh specific example of the embodiment. As shown in FIG. 28, one end of the first coupling slot 1311h is formed with the port shape, and the port shape form an angle, the angle is orientated towards the first coupling slot 1311h. Both ends of the second coupling slot 1312h do not form the port shapes with an angle.

Specifically, the first coupling slot 1311h includes a first main slot 13110h which is narrow and long, a first sub-slot 13111h which is connected to the first main slot 13110h is formed at one end of the first main slot 13110h, the first sub-slot 13111h is formed with an angle as a whole, and the angle is orientated towards the first main slot 13110h, so the first coupling slot 1311h is the shape of a unidirectional arrow. The first sub-slot 13111h closes to the second coupling slot 1312h. The second coupling slot 1312g includes a second main slot 13120h which is narrow and long. An extension line of the first main slot 13110h of the first coupling slot 1311h and the second main slot 13120h of the second coupling slot 1312h are perpendicular to each other.

Referring to FIG. 29, FIG. 29 is a scattering parameter (S-parameter) curve diagram of the radiation unit 11 using FIG. 28 as a coupling layer. Curve S291 represents a S11 value of the signal receiving end RX when the radiation unit 11 is used to receive signals; curve S292 represents a S11 value of the signal transmitting end TX when the radiation unit 11 is used to transmit signals; curve S293 represents a S12 value between the signal receiving end RX and the signal transmitting end TX. As can be seen from FIG. 29, the radiation unit 11 has a good reflection coefficient when transmitting or receiving signals, and the S12 value between the signal receiving end RX and the signal transmitting end TX of the radiation unit 11 can reach below −50 dB, which can effectively reduce the coupling effect between the first feed line 1331 and the second feed line 1332, so that the first feed line 1331 and the second feed line 1332 have better isolation.

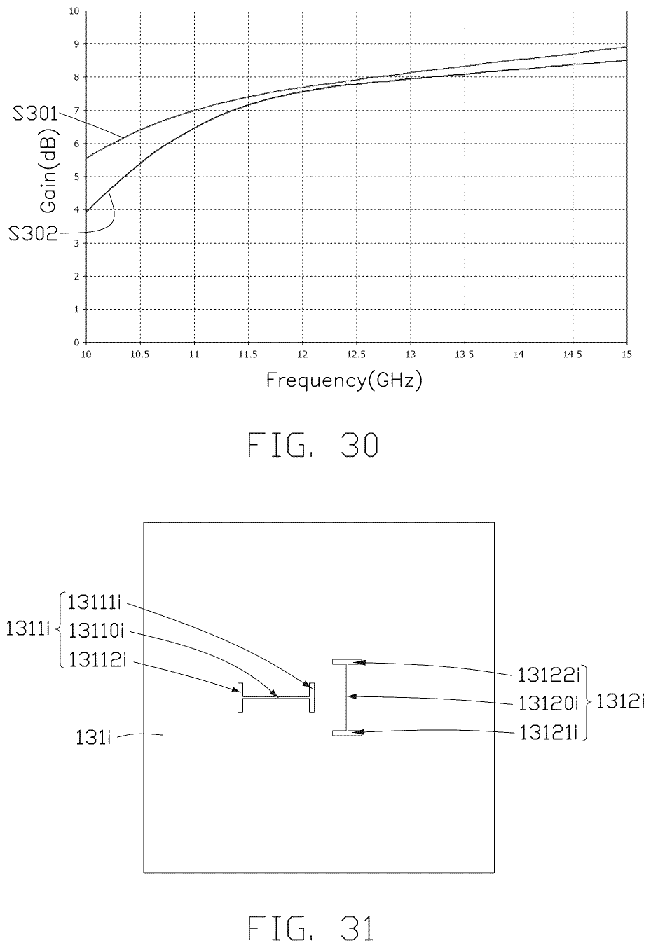

Referring to FIG. 30, FIG. 30 is an antenna gain curve diagram of the radiation unit 11 using FIG. 28 as a coupling layer. Curve S301 represents a gain value of the signal transmitting end TX when the radiation unit 11 is used to transmit signals; curve S302 represents a gain value of the signal receiving end RX when the radiation unit 11 is used to receive signals. As can be seen from FIG. 30, the radiation unit 11 of this example has a high antenna gain, which meets the antenna working requirements.

Of course, the coupling layer 131 of the embodiment of the present application is not limited to the above specific examples. For example, the port shape formed with an angle can also be formed only at one end of the second coupling slot 1312, and the angle can be toward the second coupling slot 1312, and can also be facing away from the second coupling slot 1312.

Referring to FIG. 31, FIG. 31 shows a schematic diagram of the structure of the coupling layer 131i of a ninth specific example of the embodiment. As shown in FIG. 31, both ends of each of the first coupling slot 1311i and the second coupling slot 1312i are formed with the port shapes, and the port shape does not form an angle.

Specifically, the first coupling slot 1311i includes a first main slot 13110i which is narrow and long, a first sub-slot 13111i and a second sub-slot 13112i which are connected to the first main slot 13110i are respectively formed at both ends of the first main slot 13110i, the first sub-slot 13111i and the second sub-slot 13112i are both vertically connected to the first main slot 13110i, the first sub-slot 13111i and the second sub-slot 13112i are symmetrically arranged along a center of the first main slot 13110i. The second coupling slot 1312i includes a second main slot 13120i which is narrow and long, a third sub-slot 13121i and a fourth sub-slot 13122i that are connected to the second main slot 13120i are respectively formed at both ends of the second main slot 13120i, the third sub-slot 13121i and the fourth sub-slot 13122i are both vertically connected to the second main slot 13120i, the third sub-slot 13121i and the fourth sub-slot 13122i are symmetrically arranged along a center of the second main slot 13120i. So each of the first coupling slot 1311i and the second coupling slot 1312i is H-shaped as a whole.

An extension line of the first main slot 13110i of the first coupling slot 1311i and the second main slot 13120i of the second coupling slot 1312i are perpendicular to each other. An intersection of the extension line of the first main slot 13110i of the first coupling slot 1311i and the second main slot 13120i of the second coupling slot 1312i may be a midpoint of the second main slot 13120i. Of course, it is understood that, in some other embodiments, the first sub-slot 13111i and the second sub-slot 13112i may not be symmetrically arranged along the center of the first main slot 13110i, the third sub-slot 13121i and the fourth sub-slot 13122i may not be symmetrically arranged along the center of the second main slot 13120i.

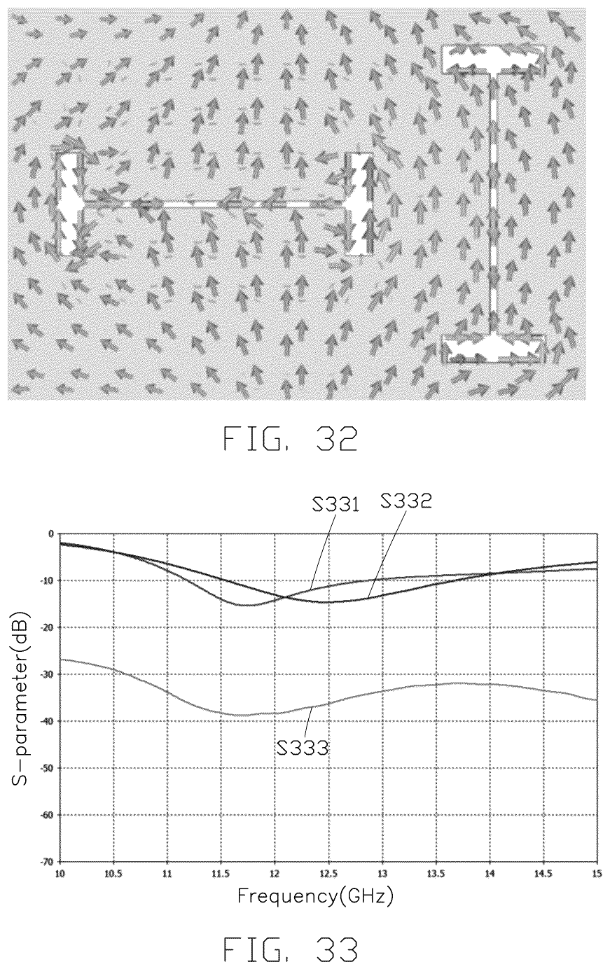

Referring to FIG. 32, FIG. 32 is a schematic diagram of current paths of the coupling layer 131i in the example of FIG. 31. According to FIG. 32, the current path and direction of the current on the coupling layer 131a are changed by the H-shaped of the first coupling slot 1311i and the second coupling slot 1312i, the current is concentrated near the port shape formed by the first coupling slot 1311i and the second coupling slot 1312i, thereby reducing the coupling interference between the first feed line 1331i and the second feed line 1332i, improving the isolation between the first feed line 1331i and the second feed line 1332i, and thus reducing the interference effect of the antenna array 10. However, compared with the current path schematic diagram of the coupling layer 131a of the first specific example shown in FIG. 6 and the current path schematic diagram of the coupling layer 131b shown in FIG. 10, the port shaped with an angle formed in the coupling layer 131a in the example of FIG. 5 and the coupling layer 131b in the example of FIG. 9 has a greater degree of change in the current path and direction. Therefore, compared with the example of FIG. 31, the coupling layer 131i can further reduce the coupling interference between the first feed line 1331 and the second feed line 1332, further improve the isolation between the first feed line 1331 and the second feed line 1332, and further reduce the interference effect of the antenna array 10.

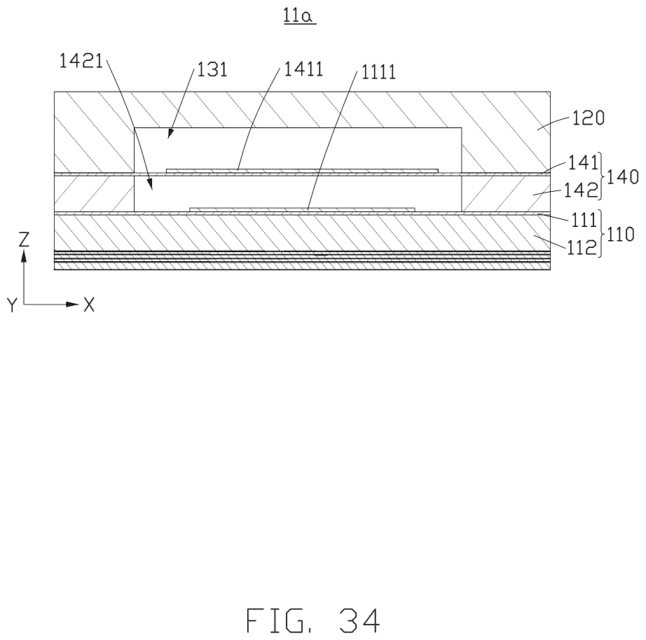

Referring to FIG. 33, FIG. 33 is a scattering parameter (S-parameter) curve diagram of the radiation unit 11 using FIG. 31 as a coupling layer. Curve S331 represents a S11 value of the signal receiving end RX when the radiation unit 11 is used to receive signals; curve S332 represents a S11 value of the signal transmitting end TX when the radiation unit 11 is used to transmit signals; curve S333 represents a S12 value between the signal receiving end RX and the signal transmitting end TX. As can be seen from FIG. 33, the reflection coefficient of the radiation unit 11 when transmitting signals is approximately −15 dB, the reflection coefficient of the radiation unit 11 when receiving signals is approximately-14 dB, and the lowest value of the S12 value between the signal receiving end RX and the signal transmitting end TX of the radiation unit 11 is approximately −38 dB. Compared with the S-parameter curves of the radiation unit 11 in the above-mentioned specific examples, although the radiation unit 11 in this example can reduce the coupling effect between the first feed line 1331 and the second feed line 1332, so that there is a certain isolation between the first feed line 1331 and the second feed line 1332, the effect is slightly worse than that of the above-mentioned examples.

In summary, the antenna array 10 provided by this application includes the first radiation module 110 and the feeding module 130. The first radiation module 110 includes the first radiation layer 111 and the first dielectric layer 112 arranged in stack, and the plurality of first radiators 1111 are provided on the first radiation layer 111. In this way, the first dielectric layer 112 can concentrate the antenna beam of each first radiator 1111 to improve the antenna gain of the antenna array 10. The feeding module 130 includes the feeding layer 133 and the coupling layer 131, the feeding layer 133 is provided with the first feed lines 1331 and the second feed lines 1332, the first feed lines 1331 and the second feed lines 1351 are arranged in one-to-one correspondence to form the plurality of feed line units, and each feed line unit corresponds to the first radiator 1111 in one-to-one correspondence. In this way, the first feed lines 1331 and the second feed lines 1351 can generate different polarized waves respectively, so that the first radiators 1111 can receive and transmit signals of two different polarized states at the same time, which can improve a system capacity of the antenna array 10, reduce interference from the antenna array 10, enhance signal quality, and improve coverage of the antenna array 10. The coupling layer 131 is provided with the first coupling slots 1311 and the second coupling slots 1312, the first coupling slots 1311 and the second coupling slots 1312 are arranged in one-to-one correspondence to form a plurality of coupling units. The first coupling slots 1311 and the second coupling slots 1312 of the coupling units are arranged at intervals from each other. In this way, when the coupling layer 131 couples the current signal flowing through the feeding units to the first radiator 1111, the coupling layer 131 changes the current path and direction of the coupling layer 131 through the first coupling slot 1131 and the second coupling slot 1312, thereby reducing the coupling interference between the first feed line 1331 and the second feed line 1332, thereby reducing the interference effect of the antenna array 10.

Further, when the extension line of the first coupling slot 1131 is perpendicular to the extension line of the second coupling slot 1312, the ends of the first coupling slot 1131 and the second coupling slot 1312 form the port shape, and the port shape is formed with an angle, the port shape formed with the angle can change the current path and direction on the coupling layer 131, and the current is concentrated near the port shape, so the coupling interference between the first feed line 1331 and the second feed line 1332 can be further reduced, and the isolation between the first feed line 1331 and the second feed line 1332 can be effectively improved, thereby effectively reducing the interference effect of the antenna array 10.

### Embodiment II

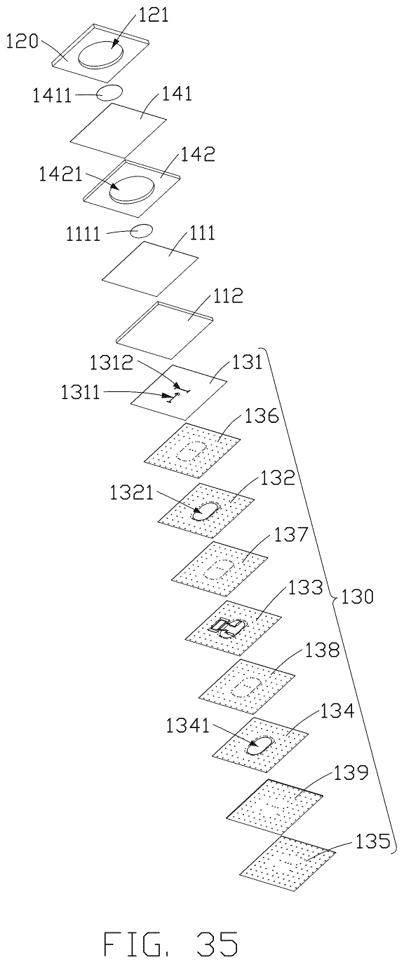

Please refer to FIGS. 34 and 35, embodiment II of the present application further provides another structure of the radiation unit 11a. The structure of the radiation unit 11a provided in the embodiment II is substantially the same as the structure of the radiation unit 11 provided in the embodiment I, the difference is that at least one radiation module in the embodiment II includes two radiation modules. And the radiation layer of one of the radiation modules is disposed close to the dielectric layer of the other one of the radiation modules. The radiators of the two radiation layers are arranged in one-to-one correspondence, and the two corresponding radiators receive the feed signal provided by the same feeding unit.

For instance, the antenna array 10 further includes a second radiation module 140. The second radiation module 140 includes a second radiation layer 141 and a second dielectric layer 142 arranged in stack. The second radiation layer 141 includes a plurality of second radiators 1411. The first radiation layer 111 of the first radiation module 110 is disposed close to the second dielectric layer 142 of the second radiation module 140. And the plurality of second radiators 1411 and the plurality of first radiators 1111 are arranged in one-to-one correspondence. In this way, the first radiators 1111 and the second radiators 1411 corresponding to each other and can receive the feed signal coupled to the feed line unit corresponding to the first radiator 1111. That is to say, after the feed line unit corresponding to the first radiator 1111 couples energy to the first radiator 1111, the first radiator 1111 continues to couple energy to the second radiator 1411 to realize signal transmission or reception of the antenna array 10. In the embodiment, the first radiation layer 111 can be a printed circuit board, the second radiator 1411 can be a substantial circular metal sheet or metal coating formed on the first radiation layer 111.

Further, the second dielectric layer 142 is also provided with a plurality of cavities 1421. Each cavity 1421 penetrates the second dielectric layer 142. A diameter of the cavity 1421 may be equal to the diameter of the corresponding protection cavity 121, an edge of the cavity 1421 is aligned with an edge of the protection cavity 121. And each cavity 1421 is provided in one-to-one correspondence with the two radiators on both sides (i.e., the first radiator 1111 and the second radiator 1411). Specifically, a line formed by centers of the cavity 1421, the first radiator 1111, and the second radiator 1411 is parallel to the Z-axis. Moreover, a projected area of the second radiator 1411 in the Z-axis direction of the antenna array 10 is larger than the projected area of the first radiator 1111 in the Z-axis direction of the antenna array 10. Thus, in the embodiment, the antenna height is further increased through the first dielectric layer 112 and the second dielectric layer 142 to increase the antenna gain; the second radiator 1411 is provided to cover the first radiator 1111 so that the energy that coupled to the second radiator 1411 by the first radiator 1111 is more concentrated, thereby increasing the directivity of the energy beam of the antenna array 10.

It can be understood that the second dielectric layer 142 can also be made of plastic or ceramic materials.

It can be understood that this application does not limit the specific shapes of the first radiator 1111 and the second radiator 1411. For example, in other embodiments, the shape of the first radiator 1111 may also be a rectangle. In other embodiments, the shapes of the first radiator 1111 and the second radiator 1411 may also be other polygonal or irregular shapes, and the shapes of the first radiator 1111 and the second radiator 1411 may be the same or different. It is only necessary that the projected area of the first radiator 1111 in the Z-axis direction of the antenna array 10 can cover the projected area of the coupling slot 1311, and the projected area of the second radiator 1411 in the Z-axis direction of the antenna array 10 can cover the first radiator 1111.

It can be understood that the working principle of the antenna array 10 provided in the embodiment II is substantially the same as that of the antenna array provided in the embodiment I. The difference is that after the feed line unit couples energy to the first radiator 1111 through the coupling slot 1311 of the coupling layer 131, the first radiator 1111 continues to couple energy to the second radiator 1411 to transmit left-hand polarized waves or right-hand polarized waves through the second radiator 1411, thereby realizing communication between the antenna array 10 and the low-orbit satellite.

Referring to FIG. 36, one embodiment of the present application also provides a radio frequency (RF) module 100. The radio frequency module 100 includes a transmitter 150 and a receiver 160. It can be understood that the transmitter 150 and the receiver 160 form a signal transceiver electrically connected to the antenna array 10 (not shown in FIG. 26, which can be referred to the antenna array 10 described above) and for providing or receiving signals to the first feed line 1331 and the second feed line 1332 in the antenna array 10.

The antenna array 10 is not limited to the antenna array 10 mentioned in the embodiment I, and may also be the antenna array composed of the radiation units provided in the embodiment II. In this way, the radio frequency module 100, by providing the antenna array 10, provided in this application can realize communication between the device installed with the radio frequency module 100 and low-orbit satellites.

Referring to FIG. 37, one embodiment of the present application also provides an electronic device 200, including a processor (such as CPU) 210, the antenna array 10, and the radio frequency module 100 shown in FIG. 36. The processor 210 is used to modulate the communication signal that needs to be radiated outward and transmit it to the transmitter 150 of the radio frequency module 100, the transmitter 150 receives the modulated communication signal to generate the feed signal, and transmits the feed signal to the first feed line 1331 and the second feed line 1332 of the antenna array 10. The processor 210 is also used to receive the external signal received by the receiver 160 of the radio frequency module 100 through the first feed line 1331 and the second feed line 1332 of the antenna array 10, and demodulate the external signal. By providing the radio frequency module 100, the electronic device 200 can communicate with low-orbit satellites. The electronic device 200 may be a ground station, a mobile vehicle, or other electronic device that needs to communicate with a low-orbit satellite.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. An antenna array comprising:
at least one radiation module comprising a radiation layer and a dielectric layer arranged in stack, the radiation layer comprising a plurality of radiators, each of the plurality of radiators configured to radiate signals, the dielectric layer being made of non-conductive material; and
a feeding module arranged on a side of the radiation module close to the dielectric layer, the feeding module comprising a feeding layer and a coupling layer arranged in stack, the feeding layer comprising a plurality of first feed lines and a plurality of second feed lines, the plurality of first feed lines and the plurality of second feed lines being one-to-one correspondingly arranged to form a plurality of feeding units, the plurality of feeding units being one-to-one corresponding to the plurality of radiators and feed current to the plurality of radiators, wherein
the coupling layer is arranged on a side of the feeding layer close to the first radiation module, the coupling layer is configured to couple the current flowing through the feeding units to the radiation module; and
the coupling layer is provided with a plurality of first coupling slots and a plurality of second coupling slots, the plurality of first coupling slots and the plurality of second coupling slots are one-to-one correspondingly arranged to form a plurality of coupling units; each of the plurality of first coupling slots is spaced apart from each of the plurality of second coupling slots.

2. The antenna array of claim 1, wherein the plurality of first coupling slots and the plurality of second coupling slots extend in different directions.

3. The antenna array of claim 1, wherein in each of the plurality of coupling units, a shape of the first coupling slot is different from a shape of the second coupling slot.

4. The antenna array of claim 2, wherein in each of the plurality of coupling units, at least one end of at least one of the first coupling slot and the second coupling slot is formed with a port shape.

5. The antenna array of claim 1, wherein the plurality of coupling units and the plurality of feeding units of the coupling layer are one-to-one correspondingly arranged; each of the plurality of first coupling slots is arranged correspondingly to a first feed line, each of the plurality of second coupling slots is arranged corresponding to a corresponding second feed line.

6. The antenna array of claim 1, wherein a length of each of the plurality of first coupling lines is same to a length of each of the plurality of second coupling lines.

7. The antenna array of claim 1, wherein the antenna array comprises two radiation modules, the radiation layer of one of the two radiation modules is arranged close to the dielectric layer of the other of the two radiation modules, the plurality of radiators of the two radiation layers are one-to-one correspondingly arranged, and the two corresponding radiators are fed by a same feeding unit.

8. The antenna array of claim 1, wherein the feeding module further comprises a first cavity layer, a second cavity layer, and a ground layer, the first cavity layer is disposed between the feeding layer and the coupling layer.

9. The antenna array of claim 1, wherein the feeding module further comprises a plurality of phase couplers, the plurality of phase couplers are arranged on the feeding layer.

10. The antenna array of claim 9, wherein the plurality of phase couplers are further connected to transmitters and receivers.

11. A ground station comprising an antenna array, the antenna array comprising:
at least one radiation module comprising a radiation layer and a dielectric layer arranged in stack, the radiation layer comprising a plurality of radiators, each of the plurality of radiators configured to radiate signals, the dielectric layer being made of non-conductive material; and
a feeding module arranged on a side of the radiation module close to the dielectric layer, the feeding module comprising a feeding layer and a coupling layer arranged in stack, the feeding layer comprising a plurality of first feed lines and a plurality of second feed lines, the plurality of first feed lines and the plurality of second feed lines being one-to-one correspondingly arranged to form a plurality of feeding units, the plurality of feeding units being one-to-one corresponding to the plurality of radiators and feed current to the plurality of radiators, wherein
the coupling layer is arranged on a side of the feeding layer close to the first radiation module, the coupling layer is configured to couple the current flowing through the feeding units to the radiation module; and
the coupling layer is provided with a plurality of first coupling slots and a plurality of second coupling slots, the plurality of first coupling slots and the plurality of second coupling slots are one-to-one correspondingly arranged to form a plurality of coupling units; each of the plurality of first coupling slots is spaced apart from each of the plurality of second coupling slots.

12. The ground station of claim 11, wherein the plurality of first coupling slots and the plurality of second coupling slots extend in different directions.

13. The ground station of claim 11, wherein in each of the plurality of coupling units, a shape of the first coupling slot is different from a shape of the second coupling slot.

14. The ground station of claim 12, wherein in each of the plurality of coupling units, at least one end of at least one of the first coupling slot and the second coupling slot is formed with a port shape.

15. The ground station of claim 11, wherein the plurality of coupling units and the plurality of feeding units of the coupling layer are one-to-one correspondingly arranged; each of the plurality of first coupling slots is arranged correspondingly to a first feed line, each of the plurality of second coupling slots is arranged corresponding to a corresponding second feed line.

16. The ground station of claim 11, wherein a length of each of the plurality of first coupling lines is same to a length of each of the plurality of second coupling lines.

17. The ground station of claim 11, wherein the antenna array comprises two radiation modules, the radiation layer of one of the two radiation modules is arranged close to the dielectric layer of the other of the two radiation modules, the plurality of radiators of the two radiation layers are one-to-one correspondingly arranged, and the two corresponding radiators are fed by a same feeding unit.

18. The ground station of claim 11, wherein the feeding module further comprises a first cavity layer, a second cavity layer, and a ground layer, the first cavity layer is disposed between the feeding layer and the coupling layer.

19. The ground station of claim 11, wherein the feeding module further comprises a plurality of phase couplers, the plurality of phase couplers are arranged on the feeding layer.

20. The ground station of claim 19, wherein the plurality of phase couplers are further connected to transmitters and receivers.
